(19) United States
(12) Patent Application Publication
(10) Pub. No.: US 2026/0291889 A1
(43) Pub. Date: Sep. 24, 2026

(54) SYSTEM

(71) Applicant: SoftBank Group Corp., Tokyo (JP)

(72) Inventor: Hiroshi TAKAHASHI, Tokyo (JP)

(73) Assignee: SoftBank Group Corp., Tokyo (JP)

(21) Appl. No.: 19/567,315

(22) Filed: Mar. 16, 2026

(30) Foreign Application Priority Data
Mar. 19, 2025 (JP) 2025-045277

(51) Int. Cl. H04L 51/02; G06F 40/166; G06N 3/0475; G10L 15/26

(52) U.S. Cl. CPC H04L 51/02; G06F 40/166; G06N 3/0475; G10L 15/26

(57) ABSTRACT

A system includes a processor that is configured to receive an input from a user as a prompt sentence and generate, based on the input, a prompt sentence for instructing a generative AI model to select and emulate a specific person, control the generative AI model to emulate wording and thought patterns of the selected person based on the generated prompt sentence, and analyze an emotion of the user and, based on a result of the analysis, adjust content and tone of a conversation by using an emotion engine.

### CROSS-REFERENCE TO RELATED APPLICATION

This application is based on and claims priority under 35 USC 119 from Japanese Patent Application No. 2025-045277 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional conversation systems using generative AI models primarily focus on generating responses based on textual content and predefined prompts, without adequately considering personalization to a specific person or adaptation to the emotional state of the user. As a result, such systems have limited ability to reproduce the wording and thought patterns of a particular historical figure, expert, or other specific person in a realistic and consistent manner. Furthermore, conventional systems do not dynamically adjust the content and tone of conversation in response to changes in the user's emotions, which can reduce user immersion, comfort, and engagement. There is therefore a need for a system that can (i) accurately emulate a specific person by controlling a generative AI model through appropriate prompts, and (ii) analyze the user's emotional state and adjust the conversation in real time, including the selection of an optimal person to emulate, so as to provide a more natural, personalized, and emotionally adaptive conversational experience.

### SUMMARY

In order to solve the above problems, the invention provides a system comprising a processor, wherein the processor is configured to receive an input from a user as a prompt sentence and generate, based on the input, a prompt sentence for instructing a generative AI model to select and emulate a specific person. The processor is further configured to control the generative AI model to emulate wording and thought patterns of the selected person based on the generated prompt sentence. The processor is also configured to analyze an emotion of the user and, based on a result of the analysis, adjust content and tone of a conversation by using an emotion engine. In some embodiments, the processor is configured to use information on historical figures or notable experts stored in a database to emulate the specific person and enable a conversation with the emulated specific person. In other embodiments, the processor is configured to process input data from the user by using an emotion analysis algorithm to analyze an emotional state of the user, select an optimal person based on a result of the analysis, and generate the prompt sentence for instructing the generative AI model to emulate the selected optimal person.

The term “system” refers to a combination of hardware and software components, including at least one processor and associated memory and interfaces, that cooperate to execute the functions described in the claims.

The term “processor” refers to one or more hardware processing units, such as a central processing unit (CPU), graphics processing unit (GPU), digital signal processor (DSP), or specialized AI accelerator, which execute instructions to perform the functions specified in the claims.

The term “user” refers to a human operator who interacts with the system by providing input data, such as text or speech, and receiving output in the form of generated responses.

The term “input from a user” refers to data, including but not limited to textual, speech, or other interaction data, that is provided by the user to the system and is used as a basis for generating prompts and conversations.

The term “prompt sentence” refers to a text string or structured textual data that is supplied to the generative AI model in order to instruct the model regarding the context, task, or manner in which a response is to be generated.

The term “generative AI model” refers to a machine learning model, such as a large language model, that is configured to generate natural language text or other content in response to a given prompt sentence.

The term “specific person” refers to an individual persona selected or defined by the system, such as a historical figure, a notable expert, or another designated character, whose wording and thought patterns are to be emulated by the generative AI model.

The term “emulate” refers to the operation of generating responses that imitate or reproduce, to a predetermined degree, the wording style, tone, and thought patterns associated with the specific person, without the system or model being that actual person.

The term “wording” refers to characteristic linguistic expressions, vocabulary, phrasing, and sentence structures that are associated with the specific person and are reflected in generated responses.

The term “thought patterns” refers to characteristic ways of reasoning, expressing opinions, structuring arguments, and selecting topics that are associated with the specific person and are reflected in generated responses.

The term “emotion of the user” refers to an affective state of the user, such as happiness, sadness, anger, anxiety, or other emotional conditions, which is inferred by the system from the user's input data.

The term “analyze an emotion of the user” refers to the operation of processing the user's input data using an emotion analysis algorithm or model to estimate or classify the user's emotional state.

The term “emotion engine” refers to a functional module implemented by hardware, software, or a combination thereof, that performs emotion analysis of the user and adjusts conversation content and tone based on the analysis result.

The term “adjust content and tone of a conversation” refers to modifying one or more aspects of generated responses, including but not limited to topic selection, response length, vocabulary, politeness level, empathy level, and stylistic features, in accordance with the analyzed emotional state of the user.

The term “database” refers to a structured data storage system, implemented in hardware and software, that stores information related to historical figures, notable experts, or other specific persons used for emulation by the generative AI model.

The term “historical figures” refers to persons from the past whose biographical information, writings, speeches, or other records are stored in the database and are used to support emulation of their wording and thought patterns.

The term “notable experts” refers to persons recognized for expertise in specific fields, such as medicine, law, science, or other domains, whose information stored in the database is used to emulate their professional style and knowledge.

The term “emotion analysis algorithm” refers to a computational method, including but not limited to machine learning models or rule-based systems, that processes user input data to estimate or classify the emotional state of the user.

The term “optimal person” refers to a specific person selected by the system, from among a plurality of candidate persons, as being most appropriate for emulation in view of the analyzed emotional state of the user or other contextual factors.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

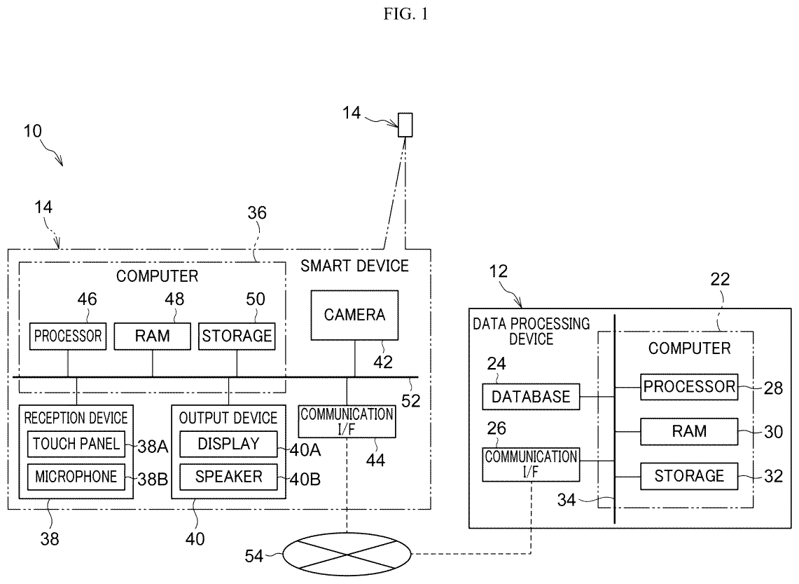

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

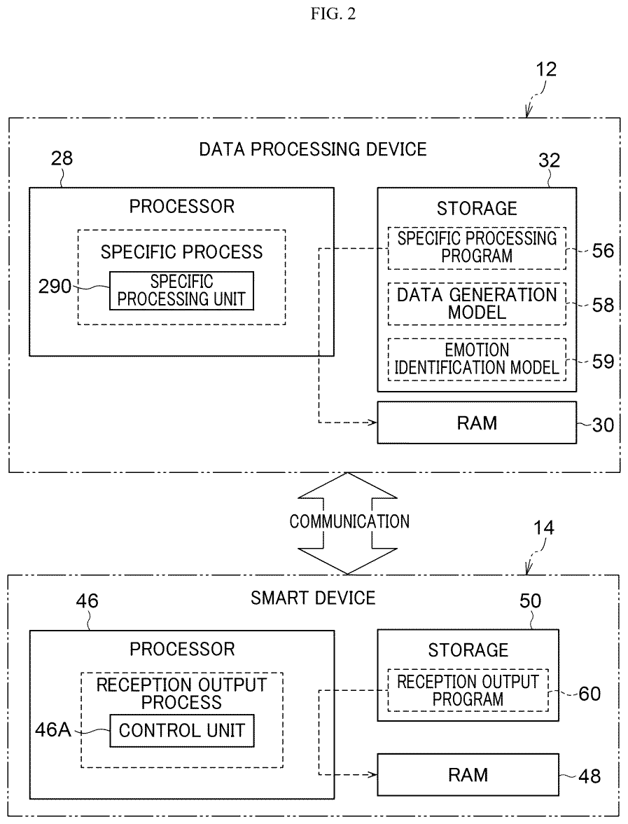

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems that utilize generative AI models typically rely on generic training data and static prompt templates. Such systems often fail to faithfully reproduce a specific individual's language expression style and topic preferences, particularly when the individual is a deceased person or another uniquely profiled person whose past conversation history is scattered across heterogeneous data sources, such as text logs and audio recordings. Existing approaches generally treat user-provided historical data as unstructured text appended to a prompt, without performing systematic, machine-executable preprocessing, normalization, and structuring of the data into training-ready units aligned with speaker attributes, temporal attributes, and contextual attributes. As a consequence, the generative AI model cannot reliably internalize the target individual's speaking patterns, leading to responses that are inconsistent, impersonal, or stylistically inaccurate.

Furthermore, known systems typically do not integrate a technical pipeline that converts raw audio data into text, applies uniform linguistic preprocessing to both text and transcribed speech, and constructs a dedicated training data set used to adjust parameters or auxiliary parameters of a generative AI model for a specific target individual. Instead, generic models are reused with superficial persona prompts, which does not adequately control token-level generation behavior in the model. This results in inefficient use of computing resources and degraded reproducibility of desired conversational behavior.

Additionally, existing conversational agents tend to react to user emotion at the surface level, such as by selecting canned replies based on simple sentiment classification. They do not technically integrate emotion analysis as an internal control signal that dynamically adjusts the content of model input prompt sentences or generation conditions of a trained generative AI model in real time. As a result, the system cannot adequately modulate conversation content and tone for different user emotion states while still maintaining the specific target individual's style, which reduces user engagement and the perceived quality of interaction. Therefore, there is a need for a computer-implemented technique that: (i) acquires heterogeneous historical conversation and behavior data for a target individual; (ii) executes a structured and automated preprocessing pipeline including natural language processing and speech recognition to generate preprocessed utterance unit data; (iii) constructs and uses a dedicated training data set to adjust parameters of a generative AI model so as to technically improve the model's ability to emulate a specific target individual; and (iv) incorporates an emotion analysis algorithm that provides control signals to adjust model input prompt sentences and generation conditions, thereby technically improving the adaptability and responsiveness of the dialog system while maintaining the target individual's style.

The specific processing by the specific processing unit 290 of the data processing device 12 in Example 1 is realized by the following means.

The present invention provides a server comprising a processor configured to acquire, from a storage unit, past conversation history data and behavior history data collected by a user, read character information and audio information included in the past conversation history data and the behavior history data as analysis target data, perform, on the character information included in the analysis target data, segmentation processing, normalization processing, unnecessary information removal processing, and format conversion processing by using a natural language processing program to integrate the processed character information as preprocessed character string data, convert, by using a speech recognition program, the audio information included in the analysis target data into character strings, perform the segmentation processing, normalization processing, unnecessary information removal processing, and format conversion processing on the converted character strings by using the natural language processing program to add resulting preprocessed character string data to the integrated preprocessed character string data, generate utterance unit data from the integrated preprocessed character string data in accordance with speaker attributes, time attributes, and context attributes of a target individual and construct a training data set for a generative AI model by using the utterance unit data, adjust parameters or auxiliary parameters of the generative AI model by using the training data set to generate a trained generative AI model that reflects a language expression style and topic preferences of the target individual, receive an input character string from a client device as a prompt sentence, designate the target individual for the trained generative AI model and generate a model input prompt sentence including conversation conditions, execute the trained generative AI model by using the model input prompt sentence and, as needed, past conversation history as input to generate a response character string that mimics the language expression style and topic preferences of the target individual, apply an emotion analysis algorithm to at least the input character string and a conversation situation to estimate an emotion state of a user, and control conversation content and a conversation tone by adjusting, in response to the estimated emotion state, at least one of contents of the model input prompt sentence and generation conditions of the trained generative AI model, and output the generated response character string to a user interface of the client device. This enables a technical improvement of computer functionality by providing a structured data processing and model adaptation pipeline that transforms heterogeneous historical text and audio data into training-ready utterance units for a target individual, by technically modifying the internal behavior of the generative AI model to emulate that individual's style, and by dynamically controlling prompt sentences and generation parameters based on emotion analysis to produce more contextually appropriate, style-consistent, and responsive dialog outputs.

The term “processor” refers to a hardware computing unit or a combination of hardware computing units, such as one or more central processing units, graphics processing units, or other programmable logic devices, configured to execute program instructions to perform data processing operations described in the present disclosure.

The term “external storage unit” refers to any non-transitory storage medium or storage system, separate from a main memory, that is configured to store data and to be accessed by the processor, including but not limited to local disk drives, removable storage media, and remote storage services accessible over a communication network.

The term “storage unit” refers to any non-transitory computer-readable storage medium or storage subsystem, including main memory, secondary storage, and network-attached storage, that is configured to store data, programs, or models for access and processing by the processor.

The term “past conversation history data” refers to data representing previous communications involving a target individual, including but not limited to message logs, chat logs, correspondence records, transcripts, and any other recorded dialog content in text or encoded form.

The term “behavior history data” refers to data representing historical patterns of actions, choices, or responses of a target individual, including but not limited to logs of activities, preferences, and behavioral attributes that can be derived from interaction records, usage histories, or other contextual information sources.

The term “character information” refers to information expressed in a symbolic text form, including letters, numerals, punctuation symbols, and other characters that can be processed as text strings by the processor.

The term “audio information” refers to information representing sound signals, including but not limited to speech recordings and voice messages, encoded in one or more audio formats and suitable for processing by a speech recognition program.

The term “analysis target data” refers to a data set that includes at least character information and audio information obtained from past conversation history data and behavior history data, and that is designated as input to preprocessing operations executed by the processor.

The term “natural language processing program” refers to a software component or collection of software components configured to perform computational operations on text, including segmentation, tokenization, normalization, removal of unnecessary information, and conversion of text formats, in order to produce structured or cleaned text suitable for further processing.

The term “segmentation processing” refers to an operation that divides a text sequence into constituent units, such as sentences, phrases, or tokens, according to linguistic rules or statistical models, to facilitate subsequent analysis and processing.

The term “normalization processing” refers to an operation that converts textual data into a canonical or standardized form, including but not limited to case normalization, removal or conversion of special symbols, and unification of equivalent expressions.

The term “unnecessary information removal processing” refers to an operation that removes or filters out elements of data deemed not useful for the intended analysis or modeling, including but not limited to headers, signatures, system notifications, noise fragments, and excessively short or irrelevant text segments.

The term “format conversion processing” refers to an operation that transforms data from one representation or structure into another, including but not limited to converting raw text into structured records, changing encoding schemes, or reformatting data to comply with a target schema.

The term “preprocessed character string data” refers to text data that has been subjected to one or more of segmentation processing, normalization processing, unnecessary information removal processing, and format conversion processing, and is thereby prepared for use in training or inference operations.

The term “speech recognition program” refers to a software component or system configured to recognize and convert audio information that includes speech into character strings representing the recognized linguistic content.

The term “utterance unit data” refers to structured data elements that represent discrete units of speech or text, such as individual sentences, messages, or dialog turns, each optionally associated with attributes such as a speaker, a time indicator, and a context indicator.

The term “speaker attributes” refers to information indicating characteristics of a speaker associated with a given utterance unit, including but not limited to identity labels such as a target individual label or an interlocutor label.

The term “time attributes” refers to information that represents temporal aspects associated with an utterance unit, including but not limited to timestamps, relative ordering, or temporal intervals in which the utterance occurred.

The term “context attributes” refers to information that represents situational or conversational context associated with an utterance unit, including but not limited to topic labels, conversation identifiers, or preceding and following dialog segments.

The term “target individual” refers to an individual, such as a specific person whose conversational style is to be emulated, for whom past conversation history data and behavior history data have been collected and used to train or adapt a generative AI model.

The term “training data set” refers to a collection of data samples, including utterance unit data and associated attributes, that is organized and used by the processor to train, fine-tune, or otherwise adjust parameters of a generative AI model.

The term “generative AI model” refers to a computational model, such as a machine learning or deep learning model, configured to generate text or other content in response to input data, and including models that accept a prompt sentence as input to produce a generated output sequence.

The term “parameters or auxiliary parameters” refers to numerical values or configurations within a generative AI model, including trainable weights, biases, adapter parameters, or other internal settings that determine the behavior and output of the model during inference.

The term “trained generative AI model” refers to a generative AI model whose parameters or auxiliary parameters have been adjusted by using a training data set so that the model exhibits a desired behavior, such as reflecting the language expression style and topic preferences of a target individual.

The term “language expression style” refers to characteristic patterns of how an individual expresses content in language, including but not limited to word choice, sentence structure, tone, and formality level.

The term “topic preferences” refers to characteristic tendencies of an individual to discuss, prioritize, or respond to particular subjects or themes within conversation.

The term “input character string” refers to text data received from a user or a client device, including but not limited to queries, questions, or other messages that are processed by the system as input.

The term “prompt sentence” refers to a text instruction, query, or combined message that is supplied to a generative AI model to condition or guide the generation of a response.

The term “model input prompt sentence” refers to a prompt sentence that has been constructed or modified by the processor to include specific instructions, conditions, or contextual information for use as input to a trained generative AI model.

The term “conversation conditions” refers to constraints or parameters that define how a conversational response is to be generated, including but not limited to tone requirements, persona specifications, topical constraints, and formatting rules included in a model input prompt sentence.

The term “past conversation history” refers to records of previous dialog exchanges between a user and the system or between parties represented in the data, which can be supplied as contextual input to the generative AI model for generating new responses.

The term “response character string” refers to text generated by a generative AI model, representing an output message or reply that is intended to be presented to a user.

The term “emotion analysis algorithm” refers to a computational procedure executed by the processor to infer an emotion state of a user based on one or more types of input data, including at least text, interaction behavior, or contextual signals.

The term “conversation situation” refers to information describing the current state of an ongoing conversation, including but not limited to recent dialog turns, interaction history, and contextual metadata such as time and topic.

The term “emotion state” refers to an inferred representation of a user's emotional condition, such as levels or categories of sentiment, arousal, or other affective dimensions derived from input data.

The term “generation conditions” refers to control parameters or settings used in executing a generative AI model, including but not limited to temperature, maximum length, sampling strategy, and constraint rules that affect the generation process.

The term “user interface” refers to a hardware and software combination, such as a graphical user interface, voice interface, or messaging interface, through which a user interacts with the system and views or inputs information.

The term “client device” refers to any computing device operated by a user, including but not limited to a terminal, a mobile device, a personal computer, or another network-connected device, configured to transmit input character strings and receive response character strings from the server.

The term “person information database” refers to a data storage structure that contains records of attribute information relating to multiple individuals, including generalized or abstracted profiles that can be used to construct a target individual profile.

The term “general person attribute information” refers to attribute data describing characteristics of individuals in a generalized form, including but not limited to demographic attributes, occupational attributes, interest areas, and typical behavioral features.

The term “target individual profile” refers to a structured representation of attributes and characteristics associated with a target individual, derived from one or more sources including general person attribute information and historical data, and used to condition the behavior of a generative AI model.

The term “candidate target individuals” refers to a plurality of potential individuals whose styles or profiles can be selected and emulated by the system, each associated with corresponding model configuration information or trained generative AI models.

The term “model configuration information” refers to information specifying how a generative AI model is to be instantiated or used, including but not limited to identifiers of model versions, parameter sets, and operational settings linked to a particular target individual.

In one embodiment, a server, a terminal, and a user cooperate to implement a dialog system that reproduces the language expression style and topic preferences of a target individual by adapting a generative AI model based on heterogeneous historical data. The server comprises one or more processors, such as central processing units and optionally graphics processing units, main memory units, and non-transitory storage units such as solid-state drives or network-attached storage. The terminal comprises a computing device such as a mobile device, a personal computer, or a tablet that communicates with the server over a communication network. The user operates the terminal to upload data, provide input, and view generated responses.

The server executes software including an operating system, such as a general-purpose server operating system, a web application framework such as a web service framework, a database management system, a natural language processing library such as an NLP toolkit or a language processing framework, a speech recognition engine or client for a speech-to-text service, and a machine learning framework such as a deep learning library. The server also stores and executes a generative AI model, which in one embodiment is a transformer-based neural network configured for language modeling.

The user uses the terminal to collect and provide past conversation history data and behavior history data relating to the target individual. The user stores electronic messages, chat logs, and other textual records as text files in a file system on a client device, and stores voice recordings as audio files in one or more audio formats. The user then operates a graphical user interface on the terminal to select these files and to initiate an upload operation. The terminal transmits the selected files and associated metadata to the server via a secure communication protocol.

The server stores the uploaded text and audio data in an external storage unit and registers metadata, such as file paths, media types, and user identifiers, in a database. The server reads character information from the text files and audio information from the audio files as analysis target data. The server uses a natural language processing program to perform segmentation, normalization, unnecessary information removal, and format conversion on the character information.

In a representative implementation, the server uses a natural language processing library to load a language model and to perform sentence segmentation and tokenization. The server normalizes the text by applying lowercasing, standardizing punctuation, and unifying variant encodings. The server removes unnecessary information by using pattern matching operations to delete headers, signatures, timestamps, and template phrases that do not contribute to the target individual's style. The server converts the resulting text into a structured format, such as a record structure in which each record contains a text field and associated attribute fields.

The server processes the audio information by using a speech recognition program. The server transmits audio signals or encoded audio files to a speech recognition engine, which may be executed locally or accessed through an external service API, and receives text transcripts. The server then passes these transcripts through the same natural language processing pipeline as the text data to generate preprocessed character string data. By applying the same segmentation, normalization, and noise removal steps to both originally textual data and transcribed audio, the server produces a uniform corpus of preprocessed character string data.

The server generates utterance unit data by grouping the preprocessed character string data into discrete conversational units. The server associates each utterance with speaker attributes indicating whether the utterance is from the target individual or from another party. The server also associates each utterance with time attributes such as timestamps or relative ordering indices, and with context attributes such as conversation identifiers or topic labels. The server stores each utterance unit as a structured record including at least a text field, a speaker field, a time field, and a context field.

The server constructs a training data set for a generative AI model by arranging utterance unit data into input-output pairs or sequences suitable for model training. For example, the server generates pairs in which an utterance by another party serves as an input and a subsequent utterance by the target individual serves as an output. The server encodes these pairs into token sequences using a tokenizer component associated with the generative AI model. Each token sequence is associated with labels or masks indicating which tokens are to be predicted during training.

The server implements the generative AI model as a transformer-based neural network comprising an embedding layer, a plurality of self-attention layers, feed-forward layers, and an output layer mapping hidden states to token probabilities. The server stores model parameters including weight matrices and bias vectors, as well as auxiliary parameters such as adapter weights or layer scaling factors. The server initializes these parameters from a pre-trained model or from a randomized state.

The server trains or fine-tunes the generative AI model by using the training data set. The server defines a loss function, such as a cross-entropy loss over predicted token distributions and target tokens. The server divides the training data set into mini-batches and, for each mini-batch, executes a forward pass in which the token sequences are embedded and propagated through the transformer layers. The server computes the loss and performs a backward pass that calculates gradients of the loss with respect to the model parameters. The server updates the parameters by using an optimization algorithm such as a gradient-based optimizer. The server may perform additional techniques, such as gradient clipping, learning rate scheduling, and early stopping, to improve stability and efficiency.

By adjusting parameters and auxiliary parameters using utterance unit data that is specifically structured according to speaker, time, and context attributes, the server configures the generative AI model to reflect the language expression style and topic preferences of the target individual. The use of structured, attribute-rich utterance units improves training efficiency and convergence, because the model receives clear, consistent input-output pairs focused on the target individual's responses. In addition, the preprocessed corpus with noise removed reduces spurious patterns, which lowers the entropy of the training distribution and thus improves accuracy in subsequent generation.

The user uses the terminal to initiate a dialog session with the target individual. The terminal displays a text input field and sends the user's input character string to the server as a prompt sentence. Example prompt sentences include:
“Tell me about the food you used to like the most.”
“Please talk about your recent hobbies before you passed away.”

The server receives the input character string and, based on the user identifier and conversation identifier, retrieves relevant past conversation history and the target individual profile. The server then generates a model input prompt sentence by combining a system-level instruction, the target individual profile, the relevant past conversation context, and the user's prompt sentence. For example, the server may construct a model input prompt sentence such as:
“You are the target individual. You respond in a warm and casual tone consistent with your past messages and preferences. The user says: Tell me about the food you used to like the most.”

The server tokenizes this model input prompt sentence and any associated context and feeds the tokenized sequence into the trained generative AI model. The server sets generation conditions, such as sampling temperature, maximum output length, and decoding strategy (for example, nucleus sampling), as part of the generation parameters. During inference, the server executes the transformer layers in a forward-only manner to compute, for each time step, the probability distribution over the vocabulary. The server selects output tokens according to the configured decoding strategy and terminates when an end-of-sequence token or a maximum length is reached. The server decodes the generated tokens into a response character string.

The server further applies an emotion analysis algorithm to at least the user's input character string and the conversation situation. The server may implement the emotion analysis algorithm using a separate neural network model, such as a text classifier that maps sequences of word embeddings to discrete or continuous emotion states, or by extracting linguistic features and computing sentiment scores. The server uses features such as polarity, subjectivity, presence of affective expressions, intensity indicators, and context cues to infer an emotion state. Based on the estimated emotion state, the server adjusts either the content of the model input prompt sentence, such as by adding instructions to be more gentle or concise, or the generation conditions, such as reducing randomness when the user appears distressed to provide more stable replies.

By controlling the model input prompt sentence and the generation conditions in this manner, the server modifies the internal behavior of the generative AI model to adapt responses without retraining the model in real time. The server thereby reduces computational load relative to retraining while still achieving fine-grained behavior control. Furthermore, the server can implement rules that dynamically switch between different target individual profiles or model configurations when the emotion analysis indicates that another type of persona would be more appropriate, which results in more robust and technically efficient use of model resources.

The terminal receives the server's response character string and displays it in a user interface. The terminal may render the response in a conversational view, optionally with an identifier or avatar associated with the target individual. The user reads the response and may provide further input, which the terminal sends as additional prompt sentences. Because the server maintains structured conversation history and model state externally, the terminal can be lightweight and need not store or process large models locally, which reduces memory requirements and power consumption on the client device.

This system yields technical improvements over conventional dialog systems. By performing structured preprocessing and attribute-based utterance construction, the server reduces noise and redundancy in the data pipeline, resulting in fewer computational steps during training and inference. By using a dedicated training data set constructed from heterogeneous sources and aligned by speaker, time, and context attributes, the server enhances the accuracy and consistency of the generative AI model's outputs, which are technically measurable in terms of reduced perplexity and improved similarity metrics between generated and reference utterances. The explicit separation of preprocessing, structuring, model training, and emotion-controlled prompting allows the server to manage resources more efficiently, such as caching preprocessed corpora, reusing trained models across sessions, and adjusting only prompt content and generation parameters at inference time.

In another embodiment, the server does not fine-tune the entire generative AI model but instead trains adapter modules or low-rank update matrices inserted into predefined layers of the transformer network. In this configuration, the server freezes the base model parameters and updates only a small subset of adapter parameters using the utterance unit training data. This structure reduces memory usage and improves training speed, allowing the system to maintain multiple target individual profiles with relatively low storage overhead. The server selects which adapter parameters to activate during inference based on the target individual profile, thereby switching styles quickly without reloading entire models.

In a further embodiment, the server compresses the preprocessed character string data and utterance unit data into compact vector representations using a sentence embedding module. The server uses these embeddings to index utterance units in a vector database. During inference, the server retrieves a small subset of relevant utterance units based on similarity between the current prompt sentence and stored embeddings. The server incorporates the retrieved utterances into the model input prompt sentence as additional context. This retrieval-augmented configuration reduces the number of tokens that need to be passed through the generative AI model by focusing on the most relevant historical data, thereby lowering computation time and network bandwidth between storage and processing units. The system is not limited to simulating deceased individuals. The same architecture can be applied to any target individual for whom sufficient historical data is available. The server can further integrate a person information database that contains generalized person attribute information to supplement or bootstrap profiles when historical data is sparse. In such cases, the server combines general attributes with limited historical utterances to form a composite target individual profile, which the server encodes into the model input prompt sentence and, where appropriate, into additional training data for adapters. This configuration supports scalable deployment of multiple profiles with controlled resource use.

Because the system defines specific data structures, such as preprocessed character string data and utterance unit data with explicit attributes, and because the server implements non-trivial training and inference flows featuring transformer architecture details, loss functions, optimizer behavior, and emotion-conditioned prompting, the described embodiments provide more than a mere automation of human conversation. The system modifies and improves the internal operation of computing machinery by structuring data, reducing noise, focusing training on relevant parameters, and dynamically controlling generation behavior. This leads to measurable technical effects, such as reduced training epochs to reach a target loss, improved inference latency due to reduced token processing and adapter-based switching, and enhanced output consistency, thereby improving computer technology itself rather than simply performing a business or mental process on a computer.

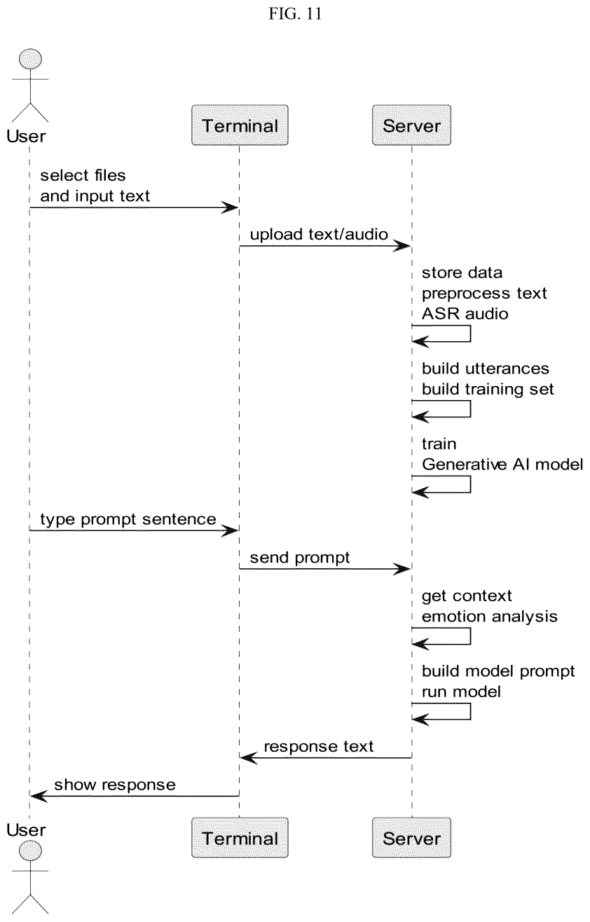

The following describes the processing flow using FIG. 11.

### Step 1

User collects and prepares historical data.
User selects past conversation history data and behavior history data of a target individual, including text messages, emails, chat logs, and voice recordings, as input. User saves the text data as text files and the audio data as audio files in a file system on a client device. User operates a graphical user interface on the terminal to choose these files using a file selection dialog and confirms the selection. The output of this step is a set of selected file paths and associated metadata ready for upload.

### Step 2

Terminal uploads historical data to the server.
Terminal receives the file paths and metadata from the user interface as input. Terminal reads the selected files from local storage and creates an upload request containing the text files, audio files, and user identifiers. Terminal performs data packaging by constructing a network request, attaching files as binary payloads, and encoding metadata as headers or request parameters. Terminal transmits the request to the server over a communication network using a secure protocol. The output of this step is an upload request containing raw historical data delivered to the server.

### Step 3

Server stores uploaded data and registers metadata.
Server receives the upload request as input. Server parses the request, extracts each file and associated metadata, and writes the files to an external storage unit. Server generates unique identifiers for each file and records file paths, file types, sizes, user identifiers, and timestamps into a database. Server performs data registration operations such as inserting database records and committing transactions. The output of this step is a set of stored files and corresponding metadata entries that define analysis target data.

### Step 4

Server preprocesses text data using natural language processing.
Server reads stored text files identified as analysis target data as input. Server invokes a natural language processing program to perform sentence segmentation, tokenization, normalization, unnecessary information removal, and format conversion on the character information. Server executes text normalization by converting characters to a unified encoding, lowercasing letters, and standardizing punctuation. Server executes noise removal by applying rule-based filters to remove headers, signatures, timestamps, and short or irrelevant lines. Server rearranges and stores the cleaned sentences as preprocessed character string data in a structured format, such as records with text fields and simple attributes. The output of this step is a standardized text corpus of preprocessed character string data derived from the original text files.

### Step 5

Server converts audio data into text and applies the same preprocessing.
Server identifies stored audio files as input. Server invokes a speech recognition program, sends the audio signals or audio files to the recognition engine, and receives text transcripts. Server then uses the same natural language processing program as in Step 4 to perform sentence segmentation, normalization, noise removal, and format conversion on the transcripts. Server integrates the resulting preprocessed character string data with the preprocessed corpus obtained from the text data. The output of this step is an expanded preprocessed text corpus that uniformly represents both originally textual data and transcribed audio.

### Step 6

Server generates utterance unit data with attributes.
Server takes the integrated preprocessed text corpus as input. Server analyzes each preprocessed character string and assigns speaker attributes, time attributes, and context attributes based on metadata and heuristic rules. Server groups related sentences into utterance units, such as individual messages or dialog turns, and constructs structured records containing at least a text field, a speaker field, a time field, and a context field for each unit. Server stores these records as utterance unit data in a dedicated data structure or table. The output of this step is a collection of utterance unit records with explicit attributes suitable for structured training.

### Step 7

Server builds a training data set for the generative AI model.
Server uses the utterance unit data as input. Server identifies pairs or sequences in which utterances from other parties precede utterances from the target individual and arranges these pairs as input-output examples. Server converts the textual content of each example into token sequences using a tokenizer component associated with the generative AI model, and creates labels indicating which tokens serve as targets during prediction. Server aggregates these tokenized examples into a training data set suitable for model training or fine-tuning. The output of this step is a structured and tokenized training data set aligned with the target individual's conversational behavior.

### Step 8

Server trains or adapts the generative AI model using the training data set.
Server loads an initial generative AI model and the training data set as input. Server executes a training procedure in which mini-batches of tokenized sequences are fed into the generative AI model. Server performs forward passes through the model's neural network layers to compute predicted token distributions, and computes a loss value, such as cross-entropy, between predicted tokens and target tokens. Server performs backward passes to calculate gradients of the loss with respect to model parameters, and updates the parameters using an optimization algorithm. Server may repeat this for multiple epochs until a convergence condition is met. The output of this step is a trained generative AI model whose parameters or auxiliary parameters are adjusted to reflect the language expression style and topic preferences of the target individual.

### Step 9

Terminal receives user input and forms a prompt sentence.
Terminal presents a text input field to the user and waits for input as the primary input of this step. User types a message, such as “Tell me about the food you used to like the most.” or “Please talk about your recent hobbies before you passed away.” and initiates sending. Terminal receives this text string, treats it as a prompt sentence, and attaches user identifiers and a conversation identifier. Terminal performs simple data formatting to prepare this information for transmission to the server. The output of this step is a request containing a prompt sentence and context identifiers ready to be sent to the server.

### Step 10:

Server constructs a model input prompt sentence with context.
Server receives the request containing the prompt sentence and identifiers as input. Server queries the database to retrieve relevant past conversation history and the target individual profile. Server composes a model input prompt sentence by embedding a system-level instruction, attributes of the target individual, optional retrieved utterance units, and the user's prompt sentence into a single text sequence. Server may, for example, generate a model input prompt sentence of the form: “You are the target individual. You respond in a style consistent with your past messages and preferences. The user says: [prompt sentence].” Server then tokenizes this composite sentence for model inference. The output of this step is a tokenized model input prompt sentence that encodes persona, context, and user query.

### Step 11

Server applies emotion analysis and adjusts generation parameters.
Server uses the current prompt sentence, conversation situation, and optionally previous user inputs as input for emotion analysis. Server executes an emotion analysis algorithm that extracts linguistic features, evaluates sentiment, and estimates an emotion state, such as calm, distressed, or joyful. Based on the estimated emotion state, Server modifies at least one of the contents of the model input prompt sentence and the generation conditions of the generative AI model. For example, Server may append instructions such as “respond in a gentle and reassuring tone” or lower the sampling temperature to produce more stable responses. The output of this step is an adjusted model input prompt sentence and updated generation conditions tailored to the user's emotion state.

### Step 12

Server generates a response character string using the generative AI model.
Server takes the tokenized and emotion-adjusted model input prompt sentence, together with the generation conditions, as input. Server executes the trained generative AI model in inference mode, computing token probabilities at each step and selecting tokens according to a decoding strategy such as greedy search or nucleus sampling. Server continues the generation process until an end-of-sequence token or a predefined maximum length is reached. Server decodes the generated tokens into a response character string, optionally performing minor post-processing to ensure readability and remove technical artifacts. The output of this step is a final response character string that mimics the target individual's language expression style and topic preferences while reflecting the user's emotion state and conversation context.

### Step 13

Terminal receives and displays the generated response.
Terminal receives the response character string from the server as input. Terminal updates the user interface by appending the response as a new message in the conversation view, associating it with the target individual's persona. Terminal may store the response locally along with the user's previous inputs to maintain a visible conversation history. The output of this step is a visual and, if desired, audible presentation of the response to the user, enabling the user to continue the dialog by providing further prompt sentences.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialogue systems and persona-based conversational agents generally generate responses based only on a current user input and a static set of textual persona data. Such systems typically send the user's text directly as input to a generative AI model, receive a text response, and optionally perform basic speech synthesis. These systems have several technical shortcomings when implemented on computing hardware.

First, conventional systems do not tightly integrate user emotion analysis, persona-specific context construction, and generative AI prompt composition in a unified control flow executed by a processor. As a result, the systems often construct prompt sentences in an ad hoc, stateless manner, which leads to inefficient use of model tokens, unstable conversational tone, and inconsistent persona reproduction across multiple turns. This can increase computation load on servers and network bandwidth, because redundant or poorly structured context must be repeatedly transmitted and processed.

Second, conventional systems do not provide an integrated mechanism in which a processor controls a full pipeline from acquisition of user audio at a terminal, conversion into character information, emotion analysis based on dialogue history, dynamic selection of a target person, generation of a structured prompt sentence for a generative AI model, and synthesis of audio data reproducing a specific voice pattern. Fragmentation of these components across uncoordinated modules causes increased latency, redundant data transformations, and complicated synchronization between text generation and speech synthesis, thereby degrading real-time performance on information processing devices.

Third, many existing techniques treat the generative AI model purely as a black box text generator, without a standardized method to build and update a prompt sentence that includes (i) target person identification information, (ii) persona attributes retrieved from a storage device, (iii) dialogue history information, and (iv) instruction information for adjusting conversation content and tone based on a user's emotional state. As a consequence, the computing system cannot optimize how internal memory structures and stored person information are mapped into the prompt sentence, and thus cannot efficiently control the generative AI model to output responses consistent with the selected persona while adapting to the user.

Fourth, typical systems do not provide processor-level control logic for maintaining a continuous multi-turn dialogue session that loops user input processing, emotion analysis, persona selection, prompt construction, generative AI invocation, and persona-specific speech synthesis as a single stateful process. Without such control, it is difficult to maintain coherent conversation state in the storage device, and the system may repeatedly reconstruct context from scratch, resulting in higher processor usage, longer response time, and reduced scalability when multiple users access the system concurrently.

Accordingly, there is a need for an improved computer-implemented system that, by means of specific processing executed by a processor and cooperative use of a storage device and a terminal, (i) constructs and updates a structured prompt sentence for a generative AI model using stored person information and dialogue history, (ii) dynamically adjusts conversation content and tone according to a user's emotional state, (iii) generates response character information reproducing a target person's speech style and thought style, and (iv) synthesizes corresponding audio data that imitates the target person's voice, all under unified control of a continuous dialogue session. Such a system can technically improve the efficiency, consistency, and responsiveness of persona-based conversational processing on computing hardware.

The specific processing by the specific processing unit 290 of the data processing device 12 in Application Example 1 is realized by the following means.

The present invention provides a server comprising a processor and a storage device, the processor being configured to receive audio information acquired from a user via a terminal, convert the audio information into character information, and generate a prompt sentence including the character information and target person identification information; to construct, based on the prompt sentence and attribute information and dialogue history information related to a target person and stored in the storage device, a further prompt sentence that instructs a generative AI model to reproduce a speech style and a thought style of the target person, and to obtain response character information that imitates a persona of the target person from the generative AI model; to execute a speech synthesis process based on the response character information and voice feature information associated with the target person, and to generate audio data that imitates a voice of the target person; to transmit the audio data and the response character information to the terminal, and to cause the terminal to present a virtual display object and to reproduce the audio data so as to provide the user with an interactive experience with the target person; to analyze an emotional state of the user based on input information from the user and the dialogue history information, and to adjust instruction information regarding conversation content and conversation tone included in the prompt sentence according to an analysis result of the emotional state; and to control a continuous dialogue session by repeatedly executing user audio input processing, response generation by the generative AI model, the speech synthesis process, and transmission processing to the terminal. This enables integration of emotion-aware prompt construction, persona-consistent text generation, and persona-specific speech synthesis within a single server-controlled processing pipeline, thereby improving computational efficiency, response latency, and coherence of multi-turn conversational interactions executed by the computer system.

The term “system” refers to a combination of hardware and software components including at least a processor, a storage device, and one or more terminals, which cooperate to perform the described conversational processing operations.

The term “processor” refers to a hardware computation unit, such as a central processing unit or a processing core, configured to execute machine-readable instructions that implement the functions described in the claims.

The term “storage device” refers to a non-transitory computer-readable medium, such as semiconductor memory, magnetic storage, or optical storage, configured to store programs, person information, dialogue history information, and other data used by the processor.

The term “terminal” refers to an information processing apparatus, such as a mobile computing device, a display device, or a head-mounted display device, configured to acquire user input and to present audio and/or visual output to the user.

The term “user” refers to a human operator who interacts with the system through the terminal by providing input information and receiving output information.

The term “audio information” refers to digital data representing sound, including a user's spoken utterance captured by a microphone of the terminal.

The term “character information” refers to textual data obtained by converting audio information into a symbolic representation of language, such as a sequence of characters or tokens.

The term “prompt sentence” refers to text data, including instructions and context, supplied to a generative AI model to control generation of response character information.

The term “target person identification information” refers to data that uniquely or selectively identifies a particular person to be reproduced by the system, such as an identifier, label, or index corresponding to stored person information.

The term “target person” refers to a person whose characteristics are to be computationally reproduced by the system, including a deceased person, a historical person, or a fictional persona.

The term “attribute information” refers to data representing characteristics of a target person, such as personality traits, typical expressions, preferences, and style descriptors, which are stored in the storage device.

The term “dialogue history information” refers to stored data representing one or more previous turns of interaction between the user and the system, including past user inputs, system outputs, and associated metadata.

The term “generative AI model” refers to a machine learning model configured to generate natural language text based on input text, including large-scale neural network models trained on language data.

The term “response character information” refers to text data generated by the generative AI model in response to a prompt sentence, which is intended to imitate the speech style and thought style of a target person.

The term “speech style” refers to linguistic characteristics of speech associated with a target person, including vocabulary, phrasing, tone, and manner of expression, as represented in text form.

The term “thought style” refers to characteristic patterns of reasoning, viewpoint, and content selection associated with a target person, as reflected in generated text.

The term “voice feature information” refers to data that represents properties of a target person's voice, such as timbre, pitch, speaking rate, and prosodic patterns, used by a speech synthesis process.

The term “speech synthesis process” refers to a computational procedure that converts text data, including response character information and voice feature information, into audio data that simulates human speech.

The term “audio data” refers to digital waveform data or encoded audio streams produced by the speech synthesis process and suitable for playback by an audio output device.

The term “virtual display object” refers to a visual representation displayed on the terminal, such as an avatar, icon, or graphical figure, associated with the target person and optionally synchronized with audio data.

The term “interactive experience” refers to a user-perceived conversational exchange in which the user provides input to the system and the system generates corresponding output that appears responsive to the user.

The term “emotional state” refers to an estimated psychological condition of the user, such as happiness, sadness, anxiety, or calmness, inferred from input information and dialogue history information.

The term “instruction information” refers to control data included in a prompt sentence, specifying desired properties of conversation content and conversation tone to be followed by the generative AI model.

The term “conversation content” refers to semantic information represented in text, such as topics, facts, and narratives, included in generated responses.

The term “conversation tone” refers to stylistic and affective properties of generated responses, such as politeness level, emotional coloring, and degree of formality.

The term “analysis result” refers to data output by an emotion analysis process that characterizes the emotional state of the user based on input information.

The term “continuous dialogue session” refers to a sequence of multiple conversational turns between the user and the system, maintained as a single interaction context by the processor.

The term “user audio input processing” refers to processing steps including acquisition of user speech by the terminal, transmission to the server, and conversion of the speech into character information.

The term “transmission processing to the terminal” refers to processing in which the processor sends generated audio data, response character information, or related control data from the server to the terminal over a communication network.

The term “person information” refers to stored data relating to an individual person, including history information, document information, conversation record information, and feature expression information.

The term “history information” refers to data describing past events, activities, or experiences associated with a person, such as biographical timelines or episodic records.

The term “document information” refers to textual materials associated with a person, including letters, diaries, articles, messages, or other written records.

The term “conversation record information” refers to stored logs of previous conversations involving a person, such as transcripts, chat logs, or recorded dialogue snippets.

The term “feature expression information” refers to structured or unstructured data that expresses characteristic linguistic or behavioral features of a person, including frequently used phrases, typical sentence patterns, or model-derived feature vectors.

The term “emotion analysis algorithm” refers to a computational method that processes user input information or dialogue history information to estimate or classify the emotional state of the user.

The term “input information” refers to data provided by the user to the system, including audio information, character information, or other signals captured by the terminal.

The term “relationship between the emotional state and a plurality of pieces of person information” refers to an association rule, mapping, or model that links different user emotional states to corresponding candidate target persons suitable for dialogue.

The term “selected target person” refers to a target person chosen by the processor from among multiple stored person entries, based on the user's emotional state or other criteria, for use in subsequent prompt sentence generation.

In one embodiment, a server cooperates with a terminal and a user to implement a persona-based conversational system as defined in the claims. The server includes a processor, a storage device, and a communication interface connected via a network to one or more terminals. The terminal includes at least a microphone, a loudspeaker or headphone interface, a display unit, a network interface, and a local processor and memory executing an application program.

The server uses the processor to execute a plurality of software modules. In one example, the server uses an operating system such as a UNIX-like operating system, an application framework such as a web application framework, a database management system such as a relational database system or a document database system, and one or more generative AI model serving components, such as a transformer-based natural language processing engine. The server also uses a speech synthesis engine, such as a neural text-to-speech engine running on a graphics processing unit or other accelerator.

The terminal executes an application that communicates with the server via a network protocol such as HTTPS over a wireless link or wired link. The terminal uses platform-specific speech recognition libraries, such as a mobile operating system speech recognition framework or a cloud-based speech-to-text service, to convert user speech into character information. The terminal uses a rendering engine, such as a 2D or 3D graphics engine, to display a virtual display object corresponding to a target person and to present synchronized audio data generated by the server.

The user uses the terminal to select a target person and to provide spoken input. The user activates a user interface element for choosing among multiple stored persons, for example, different deceased relatives or historical personas. The user then speaks towards the terminal's microphone. The terminal converts the spoken audio information into character information using an acoustic model and language model. The terminal sends the character information and associated metadata to the server.

The server stores person information in the storage device using structured data formats. In one embodiment, the server stores, for each person, a record including a person identifier, attribute information (such as textual descriptors of personality traits, typical expressions, preferred topics, tone descriptors), history information (such as episodic descriptions of past events), document information (such as letters or diary entries), conversation record information (such as past dialogue logs), and feature expression information (such as statistical counts of frequently used words or model-generated embedding vectors). The server organizes these records in normalized tables or collections so that the processor can efficiently retrieve and update them.

The server uses the processor to implement a persona construction module. The server retrieves, from the storage device, the person information corresponding to target person identification information received from the terminal. The server aggregates the attribute information, history information, document information, conversation record information, and feature expression information into an internal data structure representing a persona context, for example, a key-value map or structured object containing fields for personality, typical phrases, background memories, and behavioral rules. The server updates this persona context over time by appending new dialogue history information for each conversation session.

The server uses the processor to implement a dialogue state module. This module maintains dialogue history information per user-session pair in the storage device. The server represents the dialogue history as a sequence of structured entries, each entry containing a timestamp, a speaker role field (user or target person), a text field (character information), and optional emotion tags. The server limits the number of entries used for a single prompt sentence to a defined window size, such as the most recent several turns, to control the token length supplied to the generative AI model. By managing this dialogue state in the storage device, the server reduces redundant recomputation and network transfer of long histories.

The server uses the processor to implement an emotion analysis module. This module receives user input information represented as character information and optionally acoustic features derived from the original audio information, such as pitch contours or speaking rate. The server extracts linguistic features such as sentiment polarity scores, emotion category probabilities, and intensity measures using a classifier model, for example, a neural network trained on labeled emotion corpora, or a rule-based sentiment analyzer. The server combines these features with dialogue history features, such as counts of recent negative or positive expressions, to determine an emotional state of the user, such as “anxious,” “sad,” “relieved,” or “excited.” The server stores this analysis result as structured data attached to the current dialogue turn.

The server uses the processor to implement a prompt construction module that composes a prompt sentence for a generative AI model. In one embodiment, the server constructs a multi-part text input including (i) an instruction segment describing the role of the generative AI model, (ii) a persona description segment derived from the persona context, (iii) a dialogue history segment formed by serialized entries from the dialogue history information, and (iv) a current user input segment. The server adjusts instruction information within the instruction segment based on the emotional state. For example, when the emotion analysis module detects sadness, the server adds or strengthens instructions for a gentle, supportive tone and for avoiding abrupt topic changes.

In a concrete example, the server generates the following prompt sentence when reproducing a grandfather persona in a nostalgic style in response to a travel-related query:
“You are the recreated persona of a deceased grandfather named Taro. You are warm, humorous, and you often use the word ‘adventure’. Speak in a gentle, nostalgic tone. Based on the following background memories, answer the user as Taro in the first person, adding concrete sensory details (smells, sounds, weather) and emotions.
Background memories: [embedded travel notes, old chat logs about family trips].
User message: ‘Grandpa, tell me about our family trip when I was a child.’
Respond in English, as if you are talking directly to your grandchild.”

In another example, the server uses a Japanese-language persona description for a grandfather who frequently uses the word “adventure”:
“You are a virtual entity that recreates the personality of your deceased grandfather Taro. Grandfather often used the word “adventure” and spoke with humor and a warm, nostalgic tone. Please respond to the following user utterances in the first person with specific episodes and scenes, as if you were Grandfather Taro.
User utterance: “Grandpa, tell me a story about an old trip.”

In a further example, the server constructs a prompt sentence for a grandmother persona associated with family dinners:
“You are the recreated persona of the deceased grandmother Yuki. You loved cooking and often talked about ‘those warm evenings’ at family dinners. Answer the user in a gentle, affectionate tone, mentioning specific dishes, smells, and small anecdotes.
User message: ‘Grandma, what did you enjoy cooking the most for our family dinners?’
Respond as Yuki, in the first person, and add one or two short questions at the end to keep the conversation going.”

The server uses the processor to interface with the generative AI model. In one example implementation, the generative AI model is a transformer-based neural network having multiple attention layers, feed-forward layers, and learned embedding matrices. The model receives tokenized versions of the prompt sentence, where each token corresponds to a word or subword unit. The model includes self-attention mechanisms that compute attention weights across all positions of the input sequence, allowing the model to relate persona instructions, dialogue history, and current user input. The server supplies model parameters such as temperature, maximum token count, and top-k or top-p sampling thresholds to control diversity and safety of outputs.

The server uses the processor to call the generative AI model via an application programming interface. The storage device may retain cached model outputs and intermediate representations for diagnostic or optimization purposes. The generative AI model performs forward propagation using matrix multiplications and non-linear activation functions across multiple layers to produce a probability distribution over the vocabulary at each output step. The server decodes this distribution into response character information by sampling or greedy selection.

The server uses the processor to implement post-processing of the response character information. The server may normalize whitespace, enforce punctuation at sentence boundaries, and perform content filtering based on rule-based patterns or classification models. The server associates the response character information with the current dialogue state in the storage device, updating the dialogue history information with a new system-side entry.

The server uses the processor to implement a voice profile management module for speech synthesis. The storage device stores voice feature information for each target person, such as a vector of timbre parameters, pitch range parameters, and prosodic style parameters. In one embodiment, these voice feature parameters are produced by a prior training phase in which a neural text-to-speech model learns to approximate speech samples of the corresponding person. The server selects the appropriate voice feature information based on the target person identification information and forms a text-to-speech input structure including the response character information and the voice feature parameters.

The server uses the processor to call a neural text-to-speech engine that may be based on an encoder-decoder architecture with attention, or on a sequence-to-sequence model that first produces a mel-spectrogram and then synthesizes a waveform. The speech synthesis engine uses the voice feature information to condition its generation process, thereby controlling spectral and prosodic characteristics. The server receives audio data from the speech synthesis engine in a digital format, such as pulse-code modulation or compressed audio stream.

The server uses the processor to transmit the audio data together with the response character information and, optionally, control metadata such as viseme timing and emotion tags to the terminal via the communication interface. The terminal receives the audio data, decodes it if necessary, and plays it through the loudspeaker or headphones. The terminal may animate a virtual display object, such as a three-dimensional avatar or two-dimensional icon, by synchronizing mouth movement and facial expressions based on the viseme timing data.

The server, by controlling the entire pipeline from user audio acquisition, emotion analysis, persona selection, prompt sentence construction, generative AI model invocation, and speech synthesis, achieves technical effects beyond simple automation of human conversation. The server reduces token redundancy and improves computational efficiency by constructing compact, structured prompt sentences that selectively include only relevant parts of the dialogue history and persona attributes. This selective inclusion decreases network traffic to the generative AI model and reduces processing load, thereby decreasing response latency. The server improves accuracy and consistency of persona reproduction by integrating stored feature expression information into the prompt construction, rather than relying solely on generic instructions. The server uses specific lexical statistics and embedding-based similarity scores when choosing which phrases and background memories to insert into the persona description segment, thereby biasing the generative AI model toward language patterns that match the target person. This approach reduces variation and error in persona style, leading to more stable outputs.

The server improves the quality of emotion-adaptive conversation by using a distinct emotion analysis module that computes numerical features and emotion labels. The server maps these emotion labels to modifications of instruction information in a deterministic way, such as adjusting tone descriptors and topic instructions according to predefined rules or learned mappings. This mapping establishes a clear causal link between detected emotional state and the generative AI model's behavior, enabling reproducible adaptation rather than ad hoc style changes.

The server improves resource utilization during multi-user operation by storing and updating dialogue history information and persona contexts in a structured manner. The server avoids recomputing persona descriptions and full histories for each request by referencing persistent records in the storage device. As a result, the server can serve many concurrent sessions without linear growth in per-request computation, improving scalability.

The server, by using a transformer-based generative AI model with explicit prompt construction, leverages the model's architecture in a way that is not achievable through manual human processing. The model attends across long sequences, including instruction segments, persona descriptions, and dialogue context, and the server actively controls this sequence. This cooperation between the server's prompt construction algorithm and the model's attention patterns yields improved coherence and persona fidelity that would be difficult to obtain through manual rule-based systems.

The server can employ various learning configurations for the generative AI model and the emotion analysis model. For example, during training, the server can use a loss function combining cross-entropy for token prediction with auxiliary loss terms for persona style adherence or emotion consistency. The server can use gradient-based optimization methods to update model weights based on large corpora of dialogues annotated with persona and emotion attributes. The server can augment training data by synthetically generating paraphrases or by re-weighting examples to improve performance on emotionally sensitive contexts.

In another embodiment, the server uses alternative model architectures, such as recurrent neural networks or convolutional sequence models, as the generative AI model and as the emotion analysis model. The server can also use alternative speech synthesis engines, such as unit selection synthesis or parametric vocoder-based synthesis, when the deployment environment does not support large neural models. The main processing flow—construction of persona-aware, emotion-aware prompt sentences and subsequent generation of response character information and audio data—remains the same.

In yet another embodiment, the server adjusts system behavior to reduce communication load by performing partial processing on the terminal. For example, the terminal may perform some emotion analysis based on local models and send only compact emotion labels and summarized text to the server. The server, in turn, uses these labels directly in the prompt construction. This partitioning of computation between the terminal and the server further decreases bandwidth consumption and accelerates response.

Thus, by defining concrete data structures in the storage device, by implementing specific modules on the server for persona construction, dialogue state management, emotion analysis, prompt sentence construction, generative AI model invocation, and speech synthesis, and by coordinating these modules through explicit control logic, the system provides a technical improvement in computer-based conversational processing. The system improves response time, reduces computational load, enhances persona fidelity, and provides consistent emotion-aware interactions that cannot be readily achieved by conventional systems or by manual human operations.

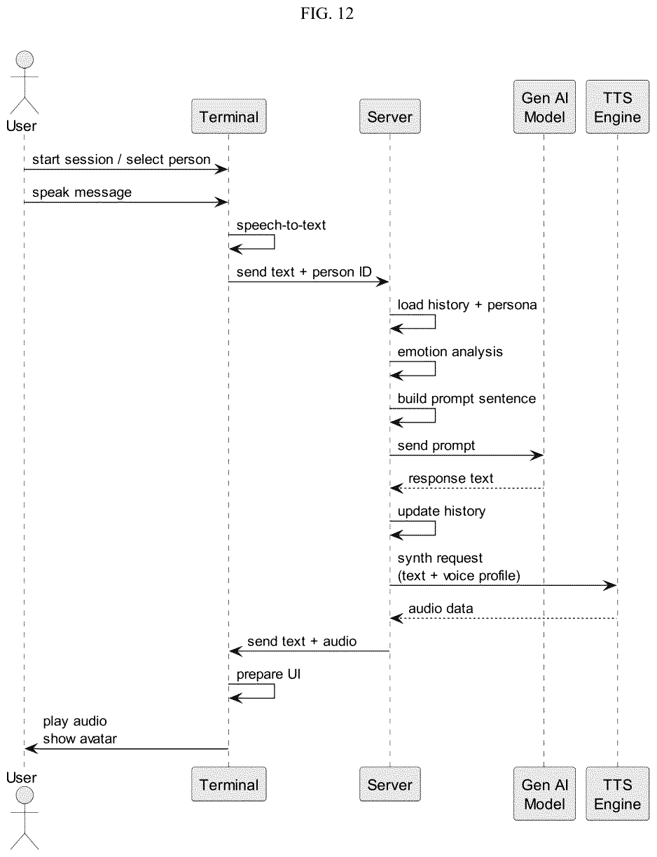

The following describes the processing flow using FIG. 12.

### Step 1

User operates the terminal to start a conversation session and to select a target person.
User provides input by launching an application on the terminal, logging in if necessary, and selecting one entry from a list of stored persons (for example, “grandfather,” “grandmother,” or a historical persona).
Terminal outputs target person identification information and session identification information as structured data, for example a pair of identifiers, and holds them in local memory to attach to subsequent user inputs. No generative AI model is called at this step.

### Step 2

User provides spoken input to the terminal.
User speaks a question or message toward the microphone of the terminal, such as “Grandpa, tell me about our family trip when I was a child.”
Terminal receives input as an analog audio signal from the microphone and converts it to digital audio samples (for example, 16-kHz, 16-bit PCM).
Terminal outputs a buffered digital audio stream together with the current session identification information and target person identification information.

### Step 3

Terminal converts the audio input into character information.
Terminal takes the buffered digital audio stream as input and calls a speech recognition module, which may be an on-device automatic speech recognition library or a remote speech-to-text service.
Terminal performs feature extraction (for example, Mel-frequency cepstral coefficients) and passes these features into an acoustic model and language model to compute the most probable word sequence.
Terminal outputs character information representing the recognized user utterance, for example the text “Grandpa, tell me about our family trip when I was a child,” and associates this text with the corresponding session identification information and target person identification information.

### Step 4

Terminal transmits recognized text and metadata to the server.
Terminal takes character information, target person identification information, session identification information, and device information as input.
Terminal constructs a structured request message including the character information and metadata and sends this message via a network protocol, such as HTTPS, to a predefined server endpoint.
Terminal outputs a network packet stream containing the structured request; from the terminal's perspective, there is no further data processing until a response is received.

### Step 5

Server receives the request and validates the input.
Server receives as input the network packet stream from the terminal, including character information, target person identification information, and session identification information.
Server decodes the network packet, checks authentication information, verifies that all required fields are present, and normalizes character encoding.
Server outputs a validated request object in server memory containing the user text, user identifiers, target person identification information, and session identification information.

### Step 6

Server retrieves and updates dialogue history information.
Server takes the validated request object as input and queries the storage device for existing dialogue history entries associated with the session identification information.
Server loads a sequence of past dialogue turns, each turn including a role label (user or target person), stored text, timestamps, and optional emotion tags, and appends the new user utterance as a candidate next entry.
Server outputs an updated dialogue history data structure, for example an ordered list of turns, and may also output a truncated view of this list limited to recent turns for use in prompt construction.

### Step 7

Server retrieves persona information for the target person.
Server takes target person identification information as input and queries the storage device for corresponding person information.
Server loads attribute information (such as personality descriptors and typical expressions), history information (such as episodic memories and event descriptions), document information (such as letters or diary fragments), conversation record information (such as past dialogues featuring that person), and feature expression information (such as frequently used words or embedding vectors).
Server outputs a persona context object that encapsulates these data items in a structured form, for example a map or structured record with fields for attributes, memories, documents, and linguistic features.

### Step 8

Server analyzes the emotional state of the user.
Server takes as input the most recent user character information and the updated dialogue history data structure.
Server applies an emotion analysis algorithm, which may include a classifier model (such as a neural network trained on sentiment and emotion labels) using input features like word embeddings, sentiment scores, and contextual tags from recent turns, and may also include rule-based checks for specific phrases.
Server computes an emotional state label (for example, “sad,” “anxious,” or “relaxed”) and optionally an intensity score, and stores or updates this information in association with the latest user turn.
Server outputs an emotion analysis result object containing the emotional state label, intensity, and relevant feature values.

### Step 9

Server constructs a prompt sentence for the generative AI model.
Server takes as input the persona context object, the truncated dialogue history data structure, the latest user character information, and the emotion analysis result object.
Server transforms these data into natural language segments: a role instruction segment, a persona description segment describing attributes and typical expressions, a memory or background segment drawn from history information and document information, a serialized dialogue history segment, and a current user message segment.
Server modifies wording in the role instruction segment and persona description segment based on the emotional state, for example by adding or emphasizing phrases like “gentle,” “encouraging,” or “calm tone” when the emotion analysis indicates sadness or anxiety. Server concatenates these segments into a single prompt sentence or multi-part prompt message that follows the expected input format for the generative AI model, such as:
“You are the recreated persona of a deceased grandfather named Taro. You are warm, humorous, and you often use the word ‘adventure’. Speak in a gentle, nostalgic tone. Based on the following background memories, answer the user as Taro in the first person, adding concrete sensory details (smells, sounds, weather) and emotions.
Background memories: [embedded travel notes, old chat logs about family trips].
User message: ‘Grandpa, tell me about our family trip when I was a child.’
Respond in English, as if you are talking directly to your grandchild.”
Server outputs the constructed prompt sentence together with configuration parameters for the generative AI model, such as maximum token length and sampling temperature.

### Step 10

Server executes the generative AI model to generate response character information.
Server takes as input the constructed prompt sentence and model configuration parameters.
Server tokenizes the prompt sentence into token identifiers and feeds these identifiers into a generative AI model, for example a transformer-based neural network with self-attention layers, positional encodings, and feed-forward layers stored on the server or an external model hosting service.
Server performs forward propagation through the model to compute probability distributions over possible output tokens at each position, then decodes these probabilities into a sequence of output tokens using a decoding strategy such as greedy search or top-p sampling.
Server converts the output tokens back into text to obtain response character information that imitates the speech style and thought style of the target person.
Server outputs the response character information as a text string and stores it in association with the current session and dialogue history.

### Step 11

Server updates dialogue history with the generated response.
Server takes as input the response character information and the updated dialogue history data structure.
Server forms a new dialogue turn entry with role label indicating the target person, text field containing the response character information, timestamp, and optional emotion or style tags.
Server appends this entry to the dialogue history data structure and persists the updated structure in the storage device, thereby maintaining a continuous multi-turn context for the session.
Server outputs the persisted dialogue history as a confirmation of state update, ready for use in subsequent turns.

### Step 12

Server prepares text input and voice parameters for speech synthesis.
Server takes as input the response character information and the target person identification information.
Server retrieves voice feature information corresponding to the target person from the storage device, including parameters for timbre, pitch range, speaking rate, and prosody.
Server formats the response character information and voice feature parameters into a text-to-speech input structure, which may include plain text or enhanced markup specifying pauses, emphasis, and sentence boundaries.
Server outputs a speech synthesis request containing the prepared text and associated voice feature information.

### Step 13

Server performs speech synthesis to generate audio data.
Server takes the speech synthesis request as input and sends it to a speech synthesis engine, such as a neural text-to-speech model that first computes a mel-spectrogram and then generates waveform samples.
Server causes the speech synthesis engine to apply the voice feature information as conditioning input so that the generated waveform reflects the specified voice characteristics of the target person.
Server receives from the speech synthesis engine a stream or file of audio data representing the synthesized speech.
Server outputs audio data in a selected audio format, such as waveform data or compressed audio, and associates it with the response character information and session identification information.

### Step 14

Server transmits audio data and response text to the terminal.
Server takes as input the audio data, the response character information, and any additional metadata such as viseme timing or emotional tone tags.
Server packages these into a response message, encodes the audio data as necessary for transfer, and sends the message to the terminal via the communication interface using a protocol such as HTTPS.
Server outputs a network response stream and may update internal logs with transmission status and timing statistics.

### Step 15

Terminal receives and prepares the response for presentation.
Terminal takes as input the network response stream from the server.
Terminal decodes the message, extracts the audio data, the response character information, and any animation control data, and stores them in local memory or temporary storage.
Terminal may optionally render subtitles or textual content on the display based on the response character information.
Terminal outputs prepared media objects: playable audio data and optional synchronized animation commands for a virtual display object.

### Step 16

Terminal presents the generated response to the user.
Terminal takes as input the prepared media objects and the current display context.
Terminal uses an audio playback module to output the audio data through a loudspeaker or headphones, and uses a graphics module to display or update a virtual display object representing the target person, synchronizing lip movements and facial expressions with the received audio and viseme timing.
Terminal outputs audible speech that imitates the target person's voice and visual representation that corresponds to the persona, thereby providing an interactive experience to the user.

### Step 17

User perceives the response and optionally continues the conversation.
User receives as input the synthesized voice and the visual representation presented by the terminal.
User evaluates the response and decides whether to ask a further question or to end the session.
User, when wishing to continue, produces new spoken input directed to the terminal, which becomes the input for a subsequent iteration starting from the audio acquisition step.
User thus contributes new character information and emotional cues, which the server will again process into a new prompt sentence and corresponding generative AI model output.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialogue systems that utilize generative AI models typically treat all conversational personas as static presets and apply a uniform dialogue-generation pipeline regardless of the user's context or emotional state. In such architectures, a server generally receives a user input, forwards the input as a prompt sentence to a generative AI model, and returns a generated response, without dynamically adjusting model configuration or persona selection based on fine-grained analysis of user signals. As a result, conventional systems suffer from several technical drawbacks.

First, conventional systems do not efficiently exploit structured person-related information stored across heterogeneous data sources. Textual corpora, such as document information, dialogue records, explanatory descriptions, and attribute information for multiple person categories, are often stored in database systems but are not systematically normalized, segmented, and encoded into a learning-data format tailored to the generative AI model. This leads to suboptimal use of storage and memory resources and limits the ability of the model to accurately reproduce speaking styles and thinking patterns of distinct person categories.

Second, existing systems typically perform prompt construction in a simplistic manner and do not maintain rich multi-turn dialogue context with adaptive persona control. User inputs and generated responses are not consistently held as structured history information, and the generative AI model is invoked on a per-turn basis with minimal context. Consequently, the conversation quality degrades over time, and the computational resources of the server, including processor and memory, are not allocated in a way that preserves the most relevant contextual information for the dialogue.

Third, conventional dialogue systems either ignore the user's emotional state or handle it in a superficial way, for example by merely tagging responses with coarse sentiment labels. There is no tightly integrated emotion analysis processing pipeline that estimates the user's emotional state from user input information and directly feeds adjustment information back into the prompt construction or model input sequence. Moreover, the selection of a person category (persona) is usually static or manually configured and is not dynamically switched in response to changes in the user's emotional state during multi-turn interactions.

These limitations lead to technical problems in the field of computer technology. The server-side processing pipeline fails to adapt the configuration of the generative AI model and the selection of person categories to evolving user states, and the system cannot efficiently transform large-scale structured person-related data into optimized learning data. This causes unnecessary computational overhead, inefficient use of memory and storage, reduced throughput, and degraded response quality and consistency in multi-turn dialogue sessions. Accordingly, there is a need for a system that technically improves the way a server constructs prompt sentences, manages model configuration, analyzes user emotion, and dynamically selects person categories in conjunction with a generative AI model, thereby improving the overall operation of the computer system that provides persona-based dialogue services.

The specific processing by the specific processing unit 290 of the data processing device 12 in Example 2 is realized by the following means.

The present invention provides a server comprising a processor configured to acquire, from a communication terminal, user input information, generate a prompt sentence including identification information indicating a person category as a dialogue target, and input the prompt sentence to a generative AI model to instruct reproduction of a specific person category; to acquire, from an information set stored in a storage device, person-related information corresponding to the identification information, convert structured person-related information including document information, dialogue record information, explanatory information, and attribute information into a learning-data format by text normalization processing, segmentation processing, and encoding processing, and set, for the generative AI model, speaking-style information and thinking-pattern information for each person category as learning data so as to generate model configuration information for dialogue generation; to generate an input sequence by combining the model configuration information, the prompt sentence, and history information including past user input information and response sentences, input the input sequence to the generative AI model to generate a response sentence, and transmit the response sentence to the communication terminal; to execute emotion analysis processing to estimate an emotional state of the user based on the user input information, generate adjustment information for changing content or an expression style of the response sentence in accordance with the emotional state, and correct the input sequence to the generative AI model or the response sentence on the basis of the adjustment information; and to select, on the basis of the emotional state and the person-related information, a person category suitable for dialogue with the user, generate a new prompt sentence corresponding to the selected person category, and dynamically switch input content to the generative AI model in a multi-turn dialogue session. This enables technical improvement of the server-side dialogue processing pipeline by optimizing transformation of structured person-related information into model-ready learning data, maintaining and exploiting multi-turn dialogue context, and dynamically controlling persona selection and response generation based on user emotional state, thereby improving computational efficiency, resource utilization, and response quality of the computer system implementing generative AI based dialogue.

The term “communication terminal” refers to an electronic apparatus operated by a user, such as a portable information processing device, a stationary information processing device, or a display-equipped input/output device, that transmits user input information to a server and receives response information via a communication network.

The term “user input information” refers to information indicating an instruction, question, or other content provided by a user, including at least text data forming a prompt sentence and optionally additional contextual data such as metadata or selection information, which is transmitted from a communication terminal to a server.

The term “prompt sentence” refers to a text sequence generated on the basis of user input information, including at least an indication of a requested dialogue content and identification information specifying a person category, and serving as input to a generative AI model for response generation.

The term “identification information” refers to information that uniquely or distinctively indicates a person category or other classification of a dialogue target, such as a category identifier, label, or index used to retrieve corresponding person-related information from a storage device.

The term “person category” refers to a classification of a dialogue persona, including, for example, a historical character classification, an expert classification, or any other role classification, that defines a style of speaking and a pattern of thinking to be reproduced by a generative AI model.

The term “generative AI model” refers to an information processing model based on machine learning, such as a neural network model or language model, that generates output data including text in response to input data, such as a prompt sentence and associated configuration information.

The term “information set” refers to an aggregation of data items stored in one or more storage devices, including structured or unstructured person-related information, which can be accessed and processed by a processor for configuring a generative AI model.

The term “storage device” refers to a hardware component or combination of hardware components, such as a magnetic storage device, a semiconductor storage device, or a solid-state storage device, that stores data including person-related information and configuration information in a non-transitory manner.

The term “person-related information” refers to information associated with a person category, including at least document information, dialogue record information, explanatory information, attribute information, or combinations thereof, that is used to configure or adapt a generative AI model for persona-specific dialogue generation.

The term “document information” refers to text data such as articles, treatises, essays, or other written materials associated with a person category, which can be used as source data for learning or configuring a generative AI model.

The term “dialogue record information” refers to information representing past conversations, transcripts, or question-and-answer exchanges associated with a person category, which can be utilized to model conversational patterns.

The term “explanatory information” refers to descriptive data explaining characteristics, background, or behavioral tendencies of a person category, including narrative profiles, summaries, or annotations that guide persona configuration.

The term “attribute information” refers to structured data describing properties of a person category, such as occupation classification, time period classification, domain classification, or style classification, which may be used for retrieval or selection of a person category.

The term “structured information” refers to information organized according to a predetermined schema or format, such as records, fields, or tables, enabling systematic processing, retrieval, and conversion into a learning-data format by a processor.

The term “text normalization processing” refers to processing that converts various text data into a standard representation, including operations such as character unification, case conversion, removal of control characters, and standardization of symbols or whitespace.

The term “segmentation processing” refers to processing that divides text data into units suitable for learning or inference by a generative AI model, such as sentences, paragraphs, utterances, or other segments.

The term “encoding processing” refers to processing that converts text data or segments into a machine-readable representation, including tokenization and conversion into token identifiers, vectors, or other encoded forms acceptable as input to a generative AI model.

The term “learning-data format” refers to a data structure or representation adapted for training, fine-tuning, or configuring a generative AI model, including encoded input-output pairs, token sequences, or other model-compatible data.

The term “speaking-style information” refers to information representing characteristic linguistic features of a person category, such as vocabulary tendencies, sentence structures, tone, and rhetorical patterns, to be reflected in generated dialogue.

The term “thinking-pattern information” refers to information representing characteristic reasoning styles, argumentative structures, and problem-solving approaches associated with a person category, which guides the generative AI model in producing persona-consistent responses.

The term “model configuration information” refers to information defining a state or setting of a generative AI model for a person category, including, for example, parameters, prompts, hyperparameters, or templates used during inference.

The term “input sequence” refers to an ordered set of elements, such as tokens or encoded representations, generated by combining at least a prompt sentence and model configuration information, and provided as input to a generative AI model.

The term “response sentence” refers to a text sequence generated by a generative AI model in response to an input sequence, representing the system's reply to the user in a dialogue.

The term “history information” refers to data representing past turns in a dialogue, including previous user input information and previously generated response sentences, which is used to maintain multi-turn context for subsequent inference by a generative AI model.

The term “emotion analysis processing” refers to processing executed by a processor to estimate an emotional state of a user on the basis of user input information, using, for example, emotion classification algorithms, sentiment analysis algorithms, or other computational methods.

The term “emotional state” refers to a condition of a user's affect, such as a positive, negative, neutral, or more granular emotional category, inferred from user input information or other signals and used to adjust dialogue behavior.

The term “adjustment information” refers to information generated on the basis of an emotional state, indicating modifications to be applied to content, style, or other aspects of a response sentence or an input sequence for the generative AI model.

The term “multi-turn dialogue context” refers to a state of interaction in which multiple consecutive exchanges between a user and a system are considered, such that prior inputs and outputs are taken into account when generating a new response sentence.

The term “information-set management apparatus” refers to a computing apparatus configured to manage, store, and provide access to an information set, including functions such as indexing, querying, and supplying structured person-related information to a server.

The term “server” refers to an information processing apparatus comprising at least one processor and one or more storage devices, configured to perform dialogue processing with a communication terminal by executing operations including prompt sentence generation, generative AI model control, person-related information processing, and emotion analysis.

The term “processor” refers to a hardware computation unit such as a central processing unit, a graphics processing unit, or a specialized accelerator, or a combination thereof, that executes instructions to implement functions including prompt generation, data transformation, model inference, and emotion analysis.

The term “dialogue generation performance” refers to the quality and effectiveness of generated responses in a dialogue, including factors such as coherence, relevance, persona consistency, and responsiveness, as evaluated in the context of system operation.

The term “persona selection” refers to a process by which a system determines a person category to be used for subsequent dialogue generation, based on criteria including person-related information and user emotional state.

In one embodiment, a server implements the claimed system by executing a dialogue application on top of a hardware and software stack designed for high-throughput generative language processing. The server uses a multi-core central processing unit (CPU), such as an x86-compatible processor, in combination with one or more graphics processing units (GPUs), such as a general-purpose parallel processor compliant with CUDA or an equivalent framework. The server uses a main memory device, such as a dynamic random access memory (DRAM) module, and a non-transitory storage device, such as a solid-state drive (SSD), to store program code, model parameters, and person-related data. The server runs an operating system, such as a UNIX-like operating system, and executes middleware including a web server process, an application server process, a database management system, and a machine learning framework, such as PyTorch or TensorFlow.

The terminal operates as a communication endpoint that interacts with the server through a communication network. The terminal uses a processor and memory to execute a browser application or a native client application, renders a graphical user interface, and sends and receives hypertext transfer protocol (HTTP) or hypertext transfer protocol secure (HTTPS) messages over a transmission control protocol/internet protocol (TCP/IP) network. The user operates the terminal to input text, to select a person category, and to view generated responses.

The user selects a person category by interacting with a graphical control element on the terminal, such as a list or menu that displays generic persona labels such as “theoretical physicist,” “philosopher,” or “domain expert.” The terminal converts the user's selection into identification information, such as a category identifier string. The terminal transmits this identification information together with a prompt sentence to the server. In one example, the user inputs a prompt sentence such as “Please explain the theory of relativity in simple terms, Mr. Einstein.” In another example, the user inputs a prompt sentence such as “As Socrates, how would you explore the question ‘What is justice?’ with me?” In a further example, the user inputs a prompt sentence such as “As a cybersecurity expert, please explain the most common web application vulnerabilities and how to prevent them.”

The server receives a request including the prompt sentence and the identification information from the terminal and processes the request by a dialogue processing module. The server accesses an information set stored in a database management system, such as a relational database server, and retrieves person-related information corresponding to the identification information. The person-related information includes document information such as textual documents, dialogue record information such as past conversation transcripts, explanatory information such as persona descriptions, and attribute information such as classifications and metadata. The person-related information is stored in structured form, for example as rows in database tables with fields for text body, source type, time stamp, and category labels.

The server converts the person-related information into a learning-data format compatible with a generative AI model by performing text normalization processing. The server normalizes character encodings, converts case, removes control characters, standardizes whitespace, and unifies punctuation in order to reduce variability and to improve tokenization efficiency. The server performs segmentation processing on the normalized text to divide the text into units such as sentences, paragraphs, utterances, or question-and-answer pairs. The server uses rule-based segmentation, such as regular-expression-based sentence boundary detection, and may further combine length-based constraints, such as a maximum number of characters or tokens per segment.

The server performs encoding processing by applying a tokenizer specific to the generative AI model. For example, the server applies a byte pair encoding (BPE) tokenizer or a subword tokenizer such as SentencePiece to map each text segment to a sequence of token identifiers. The server arranges these sequences together with label information, such as role tags (“user,” “assistant,” “system”) and person category tags, into data structures such as tensors or matrices suitable for input to the generative AI model. The server thereby forms learning data that relate the person category to representative speaking-style patterns and thinking-pattern structures.

The server loads a generative AI model from the storage device into the GPU memory using the machine learning framework. In one embodiment, the generative AI model is implemented as a transformer-based neural network including an embedding layer, a plurality of self-attention layers, feed-forward layers, layer normalization units, and an output projection layer that maps hidden states to token probabilities. The server configures the generative AI model with hyperparameters such as the number of layers, the dimension of hidden states, the number of attention heads, the vocabulary size, and the maximum sequence length. The server may apply low-rank adaptation parameters or similar fine-tuning modules to adjust the behavior of the base neural network for each person category without re-training all parameters.

The server generates model configuration information for the person category by combining pre-stored base parameters of the generative AI model with category-specific adaptation parameters or category-specific prompt templates. In a first variant, the server computes updates to a subset of weights, such as adapter layers or low-rank matrices, by minimizing a loss function, such as a cross-entropy loss, on the encoded person-related learning data. The server updates those weights by back-propagation through time, using stochastic gradient descent or a variant such as Adam, and stores the updated weights as part of the model configuration information associated with the person category. In a second variant, the server constructs a system-level prompt template that describes the persona's speaking style and thinking pattern, such as “You are a theoretical physicist. You explain complex concepts using analogies from everyday life and step-by-step reasoning.” The server stores this template as model configuration information without changing the underlying model weights. The server maintains history information representing prior turns of the dialogue between the user and the server. The server updates the history information each time the server receives new user input information or generates a new response sentence. The server generates an input sequence to the generative AI model by combining the model configuration information, the current prompt sentence from the user, and at least part of the history information. The server concatenates the persona template, previous user and system utterances, and the new prompt sentence into an ordered sequence of tokens, and the server truncates the oldest parts of the sequence if the total length exceeds a predetermined maximum context length supported by the generative AI model. This use of a managed history data structure enables the server to preserve multi-turn context in a memory-efficient manner and to avoid buffer overflow that would otherwise degrade inference speed or cause processing errors.

The server then executes inference of the generative AI model on the input sequence. The server transfers the encoded input sequence to GPU memory and instructs the machine learning framework to compute the forward pass of the transformer architecture. At each generation step, the model computes attention weights and hidden states based on the current sequence of tokens. The server selects the next token using a decoding algorithm. In one embodiment, the server applies top-k or nucleus (top-p) sampling with a temperature parameter to balance diversity and determinism. In another embodiment, the server applies beam search to explore multiple candidate sequences and select a sequence that maximizes the likelihood under the model. The server collects the generated tokens up to a termination condition, such as an end-of-sequence token or a maximum generation length, and converts the tokens back to a human-readable response sentence by the tokenizer's decoding operation.

The server integrates emotion analysis processing into this dialogue pipeline. The server applies a separate emotion analysis module to the user input information and, optionally, to the dialogue history. In one embodiment, the server uses a classifier neural network, which may also be a transformer-based model, trained to map text features to emotion labels such as “frustrated,” “confused,” “satisfied,” or “neutral.” The server encodes the user input text into token sequences and feeds them to the emotion classifier, which outputs a probability distribution over emotion classes. The server determines an emotional state by comparing the output probabilities to predetermined thresholds or by selecting the class with the highest probability. The server optionally computes a confidence score and smooths emotional state estimates across turns using a temporal filter, such as an exponential moving average, to avoid abrupt fluctuations.

The server generates adjustment information based on the estimated emotional state. For example, when the emotional state indicates confusion, the server modifies decoding parameters to reduce randomness, to make explanations more stepwise, and to include additional clarifications. When the emotional state indicates frustration, the server may adjust the persona description to adopt a more empathetic tone and shorter, more direct answers. The server realizes these adjustments by modifying internal parameters, such as the temperature, the maximum token length, or by augmenting the input sequence with meta-instructions such as “speak more slowly and provide more concrete examples.” The server thereby corrects the input sequence or the post-processed response sentence according to the adjustment information.

The server further performs dynamic person category selection based on the emotional state and the person-related information. The server maintains a mapping between person categories and suitability scores for different emotional states and dialogue contexts. The server updates these scores based on historical performance indicators, such as user satisfaction feedback or conversational success metrics, that are stored in association with prior sessions. When the emotion analysis module detects a significant change in emotional state, the server consults these scores and selects another person category when it is likely to yield a better interaction. For example, when the user appears overwhelmed by technical details, the server may switch from a highly specialized expert persona to a more pedagogical instructor persona. The server then generates a new prompt sentence with updated identification information and persona description and uses this changed configuration in subsequent input sequences.

The terminal displays the response sentence on a screen as part of a graphical dialogue interface. The terminal uses rendering routines to display the text in association with the current person category, for example by showing an icon or label indicating the selected persona. The user reads the displayed response and may enter a subsequent prompt sentence. The use of a maintained history and the dynamic adjustment of persona and tone enables the user to engage in a conversation that remains coherent over many turns, without requiring the user to repeatedly specify context or manually change personas.

The described configuration provides technical improvements to computer technology beyond a mere automation of human cognitive tasks. The server rearranges large-scale structured person-related information into compressed, model-ready learning data, which reduces redundant storage access and permits reuse of normalized and encoded data across multiple sessions. The separation of base model parameters and lightweight adaptation parameters reduces memory footprint and accelerates switching between person categories because the server does not reload full model weights for each persona transition. The management of history information and input sequence length prevents context overflow and prevents the generative AI model from performing unnecessary computation on excessively long input sequences, thereby reducing inference latency and improving throughput. The emotion-conditioned adjustment of decoding parameters provides a controlled and quantifiable modification of generation behavior at the model-input level, which reduces the number of clarification turns and thus reduces total network traffic and processing time. The server also applies non-conventional data-flow control and rule-based logic that differ from human conversational behavior. The server uses explicit rule sets to decide when to truncate history, when to re-segment input, when to trigger emotion re-evaluation, and when to initiate persona switching. These rules are implemented in deterministic algorithms that operate on concrete data structures such as token sequences, probability vectors, and emotion label arrays. As a result, the system operates in a reproducible and testable manner, which is a technical property distinct from human conversational practice.

In a further embodiment, the server can employ alternative generative AI architectures, such as encoder-decoder networks or recurrent neural networks with attention, while preserving the same overall data flow and configuration logic. The server can also employ different emotion analysis algorithms, such as support vector machines using bag-of-words features, or convolutional neural networks operating on character-level encodings, while maintaining the functional relationship between emotion analysis, adjustment information generation, and persona control. In another variant, the server can implement distributed inference across multiple GPUs or multiple physical servers, where a load balancer process assigns dialogue sessions to hardware resources in a manner that considers context length and model configuration. These variations maintain the core concept that the server generates, configures, and applies prompt sentences, history information, person-related data, and emotion-conditioned control signals as concrete data structures processed by a specific generative AI model to achieve improved dialogue generation performance.

By integrating these components and procedures, the system realizes a technical improvement in the operation of a computer-implemented dialogue platform. The server reduces computational overhead and latency through optimized data transformation and caching, improves accuracy and consistency of persona-specific responses through specialized configuration of the generative AI model, and enhances robustness of multi-turn dialogue through controlled management of history information and emotion-adaptive control of persona selection and response generation.

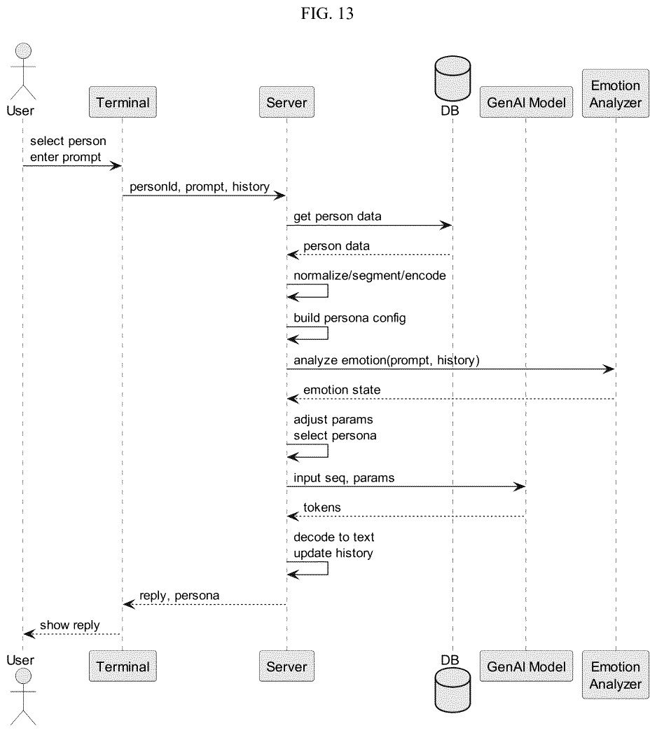

The following describes the processing flow using FIG. 13.

### Step 1

The terminal displays, on a graphical user interface, a list of person categories and an input field for a prompt sentence. The terminal uses its processor to render generic labels such as “theoretical physicist,” “philosopher,” or “domain expert,” and to activate a text input control.
Input: No external data; the terminal uses locally stored UI definitions.
Output: A visual screen state that allows the user to select a person category and enter a prompt sentence.

### Step 2

The user selects a person category on the terminal and types a prompt sentence. For example, the user types “Please explain the theory of relativity in simple terms, Mr. Einstein.” or “As Socrates, how would you explore the question ‘What is justice?’ with me?” The user then triggers a send operation by pressing a button.
Input: Displayed UI elements from the terminal (category list and text field).
Output: A selected category identifier (for example, a string such as “theoretical_physicist”) and raw text of the prompt sentence stored in the terminal's memory.

### Step 3

The terminal constructs a request message that includes the category identifier and the prompt sentence. The terminal may also attach a conversation history buffer that stores previous user inputs and server responses. The terminal formats this data into a structured representation and sends it to the server over a network using HTTP or HTTPS.
Input: The selected category identifier, the prompt sentence text, and optionally existing conversation history stored on the terminal.
Output: A network request containing structured data transmitted to the server.

### Step 4

The server receives the network request from the terminal using a web server component and an application framework. The server parses the request to extract the category identifier, the prompt sentence, and any history. The server validates this data, checking for missing fields or length limits.
Input: The structured request message from the terminal.
Output: Internal variables in server memory representing the category identifier, the prompt sentence string, and a conversation history structure.

### Step 5

The server queries a database to obtain person-related information associated with the received category identifier. The server uses a database driver to execute a query that targets tables storing document information, dialogue record information, explanatory information, and attribute information. The server aggregates the retrieved records into a unified person-related dataset.
Input: The category identifier extracted from the request.
Output: A collection of person-related records held in server memory, including multiple text fields and associated metadata for the selected person category.

### Step 6

The server performs text normalization processing on the person-related records. The server converts character encodings, normalizes case, removes control characters, standardizes whitespace, and unifies punctuation. The server processes each text field sequentially, applying deterministic rules to produce cleaned text strings.
Input: Raw person-related text fields from the database query result.
Output: Normalized text strings stored in a cleaned person-related dataset on the server.

### Step 7

The server executes segmentation processing on the normalized text. The server applies sentence boundary detection and length-based rules to split the text into sentences, paragraphs, or utterance units. The server constructs an ordered list of segments, where each segment does not exceed a predetermined length threshold.
Input: Normalized person-related text strings.
Output: A list or array of text segments, each representing a unit suitable for encoding and model processing.

### Step 8

The server performs encoding processing for the person-related segments by applying a tokenizer associated with the generative AI model. The server converts each segment into a sequence of token identifiers and groups these sequences with metadata such as role tags and category tags. The server prepares these sequences as tensors or equivalent data structures in main memory.
Input: The segmented text units and tokenizer configuration for the generative AI model.
Output: Encoded token sequences and associated metadata structures ready for use as learning data or configuration data for the generative AI model.

### Step 9

The server generates or retrieves model configuration information for the person category. The server either loads precomputed adaptation parameters or applies fine-tuning procedures such as low-rank adaptation using the encoded token sequences. The server updates or selects persona-specific parameters and/or prompt templates and associates them with the category identifier.
Input: Encoded token sequences representing person-related information and the category identifier.
Output: Model configuration information that includes persona-specific parameters and textual templates for the generative AI model.

### Step 10

The server updates and organizes history information for the current dialogue. The server merges the history received from the terminal with server-side records of past exchanges. The server prunes or truncates old entries if the combined length would exceed a defined maximum, preserving recent and relevant turns.
Input: The conversation history from the terminal and any server-side stored history, plus the current prompt sentence.
Output: A consolidated and length-controlled history structure stored in server memory for use in prompt construction.

### Step 11

The server performs emotion analysis processing on the current user input and optionally on recent dialogue turns. The server encodes the prompt sentence and selected history segments into token sequences and feeds them to an emotion classification model. The server calculates a probability distribution over emotion labels and determines an emotional state such as “confused,” “frustrated,” or “neutral” according to predefined thresholds or maximum probability selection.
Input: The current prompt sentence and selected portions of the conversation history.
Output: An emotional state label and associated scores representing the estimated emotional condition of the user.

### Step 12

The server generates adjustment information based on the emotional state. The server maps each emotional state to parameter changes, such as modifications to decoding temperature, maximum response length, and inclusion of meta-instructions in the input sequence. For example, for a “confused” state, the server sets a lower temperature and adds instructions to “explain step by step with simple examples.”
Input: The emotional state label and current model configuration information.
Output: Adjustment information that specifies parameter changes and additional text directives for the generative AI model.

### Step 13

The server optionally performs dynamic persona selection based on the emotional state and person-related information. The server evaluates suitability scores for available person categories and compares the score of the current category with alternative categories. If an alternative category is predicted to provide better interaction, the server selects that category and updates the category identifier and associated model configuration information.
Input: The emotional state, person-related metadata for multiple categories, and current category identifier.
Output: A possibly updated category identifier and updated model configuration information reflecting the selected person category.

### Step 14

The server constructs an input sequence for the generative AI model by combining persona-related text (from the model configuration information), selected history entries, and the current prompt sentence. The server concatenates these components into a single text string with role markers, then tokenizes this text using the model's tokenizer, creating a sequence of token identifiers. The server ensures that the total sequence length does not exceed the model's context limit by discarding the oldest context tokens if needed.
Input: Persona template text, updated conversation history, current prompt sentence, tokenizer configuration, and adjustment information.
Output: A finalized tokenized input sequence ready for inference by the generative AI model.

### Step 15

The server executes inference of the generative AI model using the constructed input sequence. The server transfers the token sequence to GPU memory, runs the transformer-based network forward, and iteratively generates next-token probabilities. The server applies a selected decoding method (for example, top-k sampling or beam search) with parameters modified by the adjustment information, and accumulates output tokens until a termination condition is met.
Input: The tokenized input sequence and decoding parameters derived from adjustment information.
Output: A generated token sequence representing the response content in encoded form.

### Step 16

The server decodes the generated token sequence back into natural language text. The server passes the output tokens through the tokenizer's decoding routine to obtain a response sentence. The server may apply text post-processing, such as trimming incomplete sentences, correcting spacing, and ensuring persona-consistent phrasing according to the persona template.
Input: The generated token sequence from the generative AI model.
Output: A human-readable response sentence text associated with the selected person category.

### Step 17

The server updates the history information by appending the current prompt sentence and the generated response sentence as a new dialogue turn. The server stores this updated history in its memory or in a database, marking roles (user or system) and timestamps.
Input: The previous history structure, the current prompt sentence, and the generated response sentence.
Output: An updated history structure reflecting the latest dialogue turn.

### Step 18

The server constructs a response message for the terminal, embedding the response sentence, the current person category identifier, and optional metadata such as emotional state indicators or timestamps. The server sends this response message over the network to the terminal.
Input: The response sentence text, the category identifier, and associated metadata.
Output: A structured response message transmitted from the server to the terminal.

### Step 19

The terminal receives the response message and parses it to extract the response sentence and associated information. The terminal updates its local conversation display by appending the user's last prompt sentence and the newly received response sentence in chronological order, labeling the response with the corresponding person category.
Input: The structured response message from the server.
Output: An updated visual chat log on the terminal's display showing the new response sentence.

### Step 20

The user views the updated chat log on the terminal and decides whether to continue the dialogue. If the user wishes to continue, the user inputs another prompt sentence, such as “How did you come up with the idea of spacetime, Mr. Einstein?” The user again triggers a send operation, causing the process to repeat from the earlier steps with the updated history and, if applicable, updated persona configuration.
Input: The displayed chat log and the user's intention to ask a new question.
Output: A new prompt sentence and interaction request, initiating another cycle of processing between the terminal and the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue systems using machine learning models generally treat user inputs as plain text and apply a fixed dialogue policy. Such systems typically generate responses based only on the latest input and a limited conversation history, without structured use of user emotion states, persona attributes, or user-specific style data. As a result, the systems often produce generic or context-insensitive replies that do not adapt the conversation tone to the user's emotional state, and do not consistently maintain the wording and thought patterns of a particular person or expert role.

In many implementations, a generative AI model receives only a simple prompt sentence that directly embeds the raw user input. The construction of this prompt sentence is usually ad hoc and does not formally integrate dialogue context information, persona profile information, and emotion information. Consequently, the computational resources of the generative AI model are not efficiently used, the reproducibility of persona behavior is poor, and the user experience varies unpredictably between turns.

Furthermore, existing systems rarely maintain a structured conversation state that captures both historical user inputs and generated outputs together with corresponding emotion information and persona attributes. Without such structured state, it is difficult for the system to dynamically adjust future prompt sentences and response generation based on long-term evolution of the user's emotional state. This limitation reduces the ability of the system to provide stable, emotionally appropriate, and persona-consistent conversations over multiple turns.

In addition, some systems that attempt persona simulation rely on static, hard-coded scripts or templates, which cannot flexibly respond to arbitrary user inputs or changing emotional conditions. Other systems may use a generative AI model, but they do not incorporate user-provided past data or stored person-related data into a unified prompt sentence in a systematic manner. As a result, fine-grained reproduction of an individual's conversation style based on past utterance data, vocabulary pattern data, and topic tendency data is not achieved in a scalable way.

There is therefore a need for an improved computer-implemented dialogue system that: (i) systematically constructs a prompt sentence for a generative AI model based on structured dialogue context information, emotion information, and persona profile information; (ii) dynamically selects and adjusts persona attributes and conversation tone in accordance with a user's emotional state; (iii) leverages stored person-related data and user-provided data to produce responses that consistently reflect a specific person's conversation style; and (iv) maintains and updates conversation state information so that subsequent processing steps can more effectively use prior interactions. Such improvements should enhance the technical functioning of the dialogue system as a whole, including improved control of generative model behavior, more efficient use of computational resources through targeted prompt construction, and more stable, coherent multi-turn dialogues.

The specific processing by the specific processing unit 290 of the data processing device 12 in Application Example 2 is realized by the following means.

The present invention provides a server comprising a processor configured to acquire user input data from a user terminal, generate structured dialogue context information based on the user input data and dialogue history, and use the dialogue context information for constructing a prompt sentence to be input to a generative AI model; execute emotion analysis processing on the user input data to calculate emotion information indicating an emotional state of a user, and determine, based on the emotion information, a person attribute representing a target person to be reproduced and a conversation tone attribute; acquire, from a storage device, person information and style information associated with the person attribute, the person information and the style information including at least one of past utterance data, vocabulary pattern data and topic tendency data, and generate the prompt sentence by embedding at least part of the person information and the style information together with the emotion information and the dialogue context information so as to instruct the generative AI model to select and reproduce a specific person and to define wording, thought patterns and conversation tone of the specific person; input the prompt sentence to the generative AI model, cause the generative AI model to generate a response sentence reflecting the wording, the thought patterns and the conversation tone of the specific person, and perform content filtering processing and tone adjustment processing on a generation result to determine a final response sentence; transmit the final response sentence to the user terminal and perform output control so that the final response sentence is presented by the user terminal as a text display or a speech synthesis output; and store the user input data and the final response sentence as the dialogue history and update conversation state information so that the updated conversation state information is used for subsequent generation of the dialogue context information and the emotion information. This enables improved control of the behavior of the generative AI model through structured prompt sentence construction, dynamic selection and adjustment of persona attributes and conversation tone in accordance with the user's emotional state, and technically enhanced multi-turn dialogue management that yields more coherent, consistent and context-appropriate responses while efficiently utilizing computational resources.

The term “processor” refers to a hardware or virtual information processing unit, such as a central processing unit or a programmable logic unit, that executes instructions to perform data acquisition, analysis, generation, and control operations in the system.

The term “user terminal” refers to an information processing apparatus operated by a user, such as a mobile communication device, a personal computer, or a head-mounted display, that is capable of transmitting user input data to the server and presenting response data from the server.

The term “user input data” refers to information provided by the user through the user terminal, including at least one of text data, audio data, and metadata, which is used as a basis for generating dialogue context information, emotion information, and prompt sentences.

The term “dialogue history” refers to stored information representing a sequence of past interactions between the user and the system, including at least user input data, generated response sentences, associated timestamps, and related metadata.

The term “dialogue context information” refers to structured data derived from the user input data and the dialogue history, representing conversation topics, intents, and prior turns, which is used to construct a prompt sentence for a generative AI model.

The term “prompt sentence” refers to an instruction text or a set of instruction texts provided as input to a generative AI model, the instruction text specifying conditions such as persona attributes, wording style, thought patterns, conversation tone, and contextual information to control generation of a response sentence.

The term “generative AI model” refers to a machine learning model, such as a neural network-based language model, that generates new data, including natural language text, in response to input data such as a prompt sentence.

The term “emotion analysis processing” refers to computational processing that analyzes user input data to estimate an emotional state of the user, by applying an emotion analysis algorithm or model to derive emotion information.

The term “emotion information” refers to data representing an estimated emotional state of the user, including at least one of categorical labels, numerical scores, or multi-dimensional vectors indicative of emotions such as sadness, anxiety, joy, or confusion.

The term “person attribute” refers to data specifying characteristics of a target person or role to be reproduced by the system, including information such as a profession, a persona category, or an identifier of a specific individual or archetype.

The term “conversation tone attribute” refers to data specifying a desired style or manner of communication, including at least one of calm, cheerful, formal, casual, sympathetic, or authoritative tones, which is to be applied to a generated response sentence.

The term “storage device” refers to a hardware or virtual memory component, such as a non-volatile memory device or a database system, that stores person information, style information, dialogue history, and other data used by the processor.

The term “person information” refers to data related to a particular person or persona, including at least one of biographical data, past utterance data, and domain-related knowledge used to reproduce that person's behavior or style.

The term “style information” refers to data describing linguistic and behavioral characteristics of a person or persona, including at least one of vocabulary pattern data, sentence structure patterns, politeness levels, and topic tendencies.

The term “past utterance data” refers to previously recorded or synthesized statements associated with a person or persona, such as sentences, phrases, and dialogues, which are used to model that person's typical way of speaking.

The term “vocabulary pattern data” refers to data describing characteristic word choices, idioms, and lexical preferences of a person or persona, derived from past utterance data or other text sources.

The term “topic tendency data” refers to data indicating preferred or frequently addressed subjects, themes, or domains of a person or persona, which are used to guide selection of topics in generated responses.

The term “response sentence” refers to a natural language text output generated by the generative AI model in response to a prompt sentence, before any post-processing by the system.

The term “final response sentence” refers to a response sentence that has been post-processed by the system through at least one of content filtering processing and tone adjustment processing, and is determined to be suitable for presentation to the user.

The term “content filtering processing” refers to computational operations that analyze and modify a generated response sentence to remove, mask, or alter content that does not comply with predetermined rules, policies, or safety constraints.

The term “tone adjustment processing” refers to computational operations that modify wording, style, or structure of a generated response sentence to better match a desired conversation tone attribute or emotion information.

The term “output control” refers to processing performed by the processor to cause the user terminal to present the final response sentence in a particular form, such as text display or speech synthesis output, including control of transmission timing and format conversion.

The term “speech synthesis output” refers to audio data generated from text data by a text-to-speech process and presented through a sound output device of the user terminal.

The term “conversation state information” refers to structured data representing the current state of an ongoing dialogue, including at least the latest emotion information, the selected person attribute, the conversation tone attribute, a summary of recent turns, and other variables used to influence subsequent processing.

The term “person profile information” refers to aggregated and structured data representing characteristics of a person or persona, including at least person-related data stored in a storage device and user-provided data, from which past utterance data, vocabulary pattern data, and topic tendency data are derived.

The term “person-related data” refers to data associated with a specific person or persona, including at least one of documents, messages, interaction logs, and descriptive records used for constructing person profile information.

The term “user-provided data” refers to data supplied by the user to the system, including at least one of text files, message logs, and annotations, that describe or exemplify a particular person's communication style or behavior.

The term “plurality of types of person attributes” refers to multiple predefined or dynamically generated person attribute options, each representing a different role, persona, or style, which may be selected based on emotion information or other criteria.

The term “mitigate or amplify the emotional state” refers to influencing a user's emotional state by generating responses that are designed either to reduce the intensity of a negative or positive emotion or to reinforce or strengthen a particular emotional state, according to a system configuration or objective.

Embodiments for carrying out the invention are described below.

In the following description, a “server” denotes an information processing apparatus including at least one processor and at least one storage device, a “terminal” denotes an information processing apparatus operated by a user, and a “user” denotes a human operator of the terminal.

### 1. Overall System Configuration

The server executes a dialogue control program stored in a non-transitory computer-readable medium. The server includes a multi-core central processing unit (CPU), a main memory, a network interface, and one or more storage devices such as a magnetic disk or a solid-state drive. The server may further include an accelerator such as a graphics processing unit (GPU) dedicated to execution of a generative AI model.

The terminal includes a processor, a memory, a display device, an input device such as a keyboard, a pointing device or a touch panel, a microphone, a speaker, and a communication interface. In some embodiments, the terminal is a smartphone; in other embodiments, the terminal is a head-mounted display that provides an immersive or augmented reality environment.

The server executes the dialogue control program as multiple functional modules, including at least: a user input acquisition module, a dialogue history management module, a dialogue context generation module, an emotion analysis module, a persona selection module, a profile retrieval module, a prompt generation module, a generative AI invocation module, a response post-processing module, and an output control module.

The server, in some embodiments, uses existing software services as subcomponents. For example, the server may use a speech recognition service such as a generic cloud speech-to-text service to convert audio data into text, and a text-to-speech service to synthesize speech from text for output via the terminal. The server may also use general-purpose natural language processing libraries for tokenization, part-of-speech tagging and sentence segmentation. However, the essential functions for constructing the prompt sentence, maintaining conversation state, and controlling the generative AI model are implemented by the dialogue control program itself.

### 2. Data Structures and Storage

The server stores data in structured forms optimized for efficient access and processing. The server stores dialogue history in a relational database table that includes at least the following fields: conversation identifier, turn index, user identifier, persona identifier, timestamp, user input text, generated response text, emotion label, and auxiliary metadata. By indexing these fields, the server can retrieve relevant past turns in constant or logarithmic time, which improves prompt construction speed.

The server stores person profile information in a separate table or document store. Each person profile record includes a person identifier, person attributes (for example, role category, domain of expertise), compressed past utterance data, vocabulary pattern data, topic tendency data, and style descriptors. The server, in one embodiment, calculates vocabulary pattern data by computing word frequency distributions, n-gram statistics, and part-of-speech co-occurrence patterns from historical texts associated with the person. The server calculates topic tendency data by applying a topic model such as a latent Dirichlet allocation model or by clustering sentence embeddings.

The server stores emotion information in an emotion history structure that links each user utterance and each system response to an emotion vector. The emotion vector may have fixed dimensions corresponding to basic emotions (for example, sadness, joy, anger, fear, surprise, calmness), with each component representing a numeric score. The server uses this data for smoothing and for detecting trends in the user's emotional state.

By structuring the data in this way, the server reduces repeated computation, shortens look-up time when building prompt sentences, and improves the responsiveness of the dialogue system.

### 3. Generative AI Model Configuration

The server uses at least one generative AI model configured as a neural network-based language model. The generative AI model may be a transformer-type architecture comprising multiple self-attention layers, feedforward layers, layer normalization units, and embedding layers. The model parameters include token embeddings, position embeddings, attention weights, and parameters of the feedforward sub-layers.

The server, in a first embodiment, accesses a remote generative AI model provided as a cloud service. The server constructs a prompt sentence and sends it to the remote model via an application programming interface, receiving a generated response as text. In other embodiments, the server executes a locally deployed generative AI model, optionally using a GPU.

The server, during training of a local generative AI model, uses a loss function such as cross-entropy between predicted tokens and ground truth tokens. The server updates model weights by gradient descent, for example by using stochastic gradient descent, Adam optimization, or a similar optimizer. The server may also perform data augmentation by adding noise to training texts, shuffling sentence segments within limited bounds, or injecting paraphrases, thereby improving model robustness to varied inputs.

The server defines a token limit for prompts and outputs, and configures model parameters such as temperature, top-k, or top-p sampling to control response diversity. By adjusting these parameters in conjunction with the prompt sentence composition, the server can effectively manage computational load and control the stylistic output of the generative AI model.

### 4. Emotion Analysis and Persona Selection

The server implements an emotion analysis module as a combination of deterministic feature extraction and a classifier model. The server, for each user input text, performs tokenization and mapping of each token to a vector representation (for example, a word embedding or a context-sensitive embedding). The server then aggregates token vectors into a sentence-level vector and inputs this vector into a neural network classifier or a trained statistical model.

The server, through the classifier, outputs a probability distribution across predefined emotion categories. The server converts these probabilities into emotion information, such as a label for the most probable category and a vector of scores, and stores the emotion information alongside the dialogue history.

The server uses the emotion information to select a person attribute. For example, when the emotion label indicates confusion, the server selects a philosopher persona with a style descriptor of “analytical and reflective.” When the emotion label indicates anxiety, the server selects a persona characterized as a “calm advisor” or “reassuring leader.” The selection is not a static mapping, but a computation over a table of candidate persona attributes, in which each candidate is associated with an emotion response strategy. The server may compute a score for each candidate persona as a function of the emotion vector and a preconfigured response matrix, and chooses the persona with the highest score.

By performing persona selection as a machine-driven optimization over structured attributes and emotion vectors, the server uses the computing device to perform a type of multi-dimensional matching that is difficult to perform consistently and efficiently by human operators. This contributes to a technical effect of improved consistency and speed in persona selection and tone control.

### 5. Prompt Sentence Generation

The server constructs the prompt sentence by combining multiple components in a structured way rather than concatenating raw text. The server first retrieves recent turns from the dialogue history and summarizes them into a compact representation if necessary, such as bullet points or a short narrative produced by a lightweight summarization algorithm. The server then retrieves the selected person profile information, including key vocabulary patterns and topic tendencies.

The server creates multiple sub-sections of the prompt sentence, for example:
(1) A system instruction section that describes the role of the generative AI model, such as:
“You are a compassionate advisor acting as a specific person. Follow the style and thought patterns described below, and respect safety and politeness constraints.”
(2) A persona description section that encodes person attributes and style information, such as:
“The person is a scientist known for clear explanations and careful reasoning. Use simple but precise language, provide step-by-step logic, and avoid slang.”
(3) An emotion context section that encodes emotion information, such as:
“The user is currently anxious. Respond in a calm and reassuring tone, and avoid language that may increase anxiety.”
(4) A history summary section that encodes recent dialogue context, such as:
“Previously, the user asked about the basics of relativity and you provided an overview of time dilation.”
(5) A current user input section, such as:
“User: I still feel confused about how time can move differently for two people. Can you explain again in a different way?”

The server concatenates these sections into a single prompt sentence or into a set of ordered messages in a format required by the generative AI model. The server removes redundant information to respect the token limit. The server, by dividing and composing the prompt sentence in this structured manner, reduces the need for the generative AI model to infer missing context from scratch, which improves generation accuracy and reduces unnecessary computation.

### Example Prompt Sentences Are

“You are a historical scientist. Answer the user's questions using that scientist's wording and thought patterns. The user asks: ‘Can you explain relativity in simple terms?’”
“You are a physician. The user is worried about health. Answer clearly and kindly as a physician, without making a formal diagnosis. User: ‘I want to talk with a doctor about my health.’”
“You are a fashion expert helping a nervous user prepare for a job interview. The user said: ‘I am looking for a new suit and I feel a bit nervous about an upcoming interview.’ Suggest suit styles and colors using a calm and reassuring tone.”
“The user feels lonely and sad. Act as the user's deceased father, using gentle wording and everyday topics from the father's typical style. Provide warm, comforting words. User: ‘I feel lonely today.’”

By systematically generating such prompt sentences based on structured internal data, the server improves control over the behavior of the generative AI model, which is a technical effect beyond simply automating human conversation.

### 6. Response Generation and Post-Processing

The server sends the constructed prompt sentence to the generative AI model and receives a response sentence as a sequence of tokens. The server then performs content filtering processing using a rule-based engine and, in some embodiments, an auxiliary classifier. The server checks for prohibited patterns, such as personally identifiable information, disallowed topics, or unsafe instructions. The server removes or replaces problematic segments and, if necessary, requests a regeneration from the generative AI model with additional constraints.

The server performs tone adjustment processing by evaluating the generated response sentence against the desired conversation tone attribute. The server may compute a tone score by applying a second classifier that detects formality, positivity, or calmness. If the score deviates from a threshold, the server modifies specific phrases using a deterministic rewriting rule set, for example replacing harsh expressions with milder alternatives, or reducing excessive exclamation marks.

These post-processing steps are implemented as algorithmic modules that operate on the text output of the generative AI model. They provide an additional technical control layer that stabilizes system behavior, reduces variance in style, and improves user safety. This control layer is specific to the computer-implemented system and does not correspond to a direct human equivalent.

### 7. Interaction With the Terminal

The terminal receives the final response sentence and associated metadata from the server and displays it in a user interface. The terminal, if configured, invokes a text-to-speech engine to synthesize speech from the final response sentence and plays the audio through the speaker. The terminal may also animate an on-screen or virtual avatar that represents the persona, by mapping sentence boundaries to lip-sync animations.

In embodiments where the terminal is a head-mounted display, the terminal overlays the textual or audio output in a virtual environment, such as a virtual store or a virtual meeting room. The terminal may display products, objects, or other content in synchrony with the generated responses. This integration of generated dialogue with visual and audio output in real time creates a concrete technical use in the real world: the system controls the behavior of hardware devices (display, speaker and sensors) based on the computed final response sentence and conversation state information.

### 8. Technical Effects and Improvement of Computer Technology

The server, by implementing the above-described data structures and processing modules, achieves several technical effects. First, the structured storage and retrieval of dialogue history and person profile information reduce redundant computations and allow prompt sentences to be built more efficiently. The server, by summarizing long histories and selecting only relevant past turns, reduces the number of tokens sent to the generative AI model, which reduces network traffic and inference time.

Second, the separation of emotion analysis, persona selection, and prompt generation modules allows the server to reuse emotion information and persona attributes across multiple turns, without recalculating them from scratch. This reduces processor load and improves overall processing speed.

Third, the systematic control of the generative AI model through structured prompt sentences, tone adjustment processing, and content filtering provides a more deterministic behavior from a stochastic model. This leads to lower variance in outputs, improved precision in persona reproduction, and fewer errors caused by irrelevant or unsafe generations. From a computer technology viewpoint, the system effectively wraps a large, general-purpose model with a specialized control architecture that constrains its operation to a well-defined subspace, thereby improving reliability and computational efficiency.

Fourth, the emotion-driven persona selection and tone adaptation are implemented by explicit algorithms operating on numeric emotion vectors and attribute matrices. These algorithms are not simple automation of human decisions but are based on continuous optimization and mapping that consider multi-dimensional data and history. This type of mapping and control is particularly suited to execution by a computing apparatus and provides improved coherence and stability over ad hoc human configuration.

Fifth, the server's use of machine learning models for both generation and classification, together with domain-specific rules for post-processing, allows mixed symbolic and sub-symbolic control circuits that achieve better responsiveness and accuracy than either approach alone. For example, neural classifiers detect subtle emotion cues, and rule-based filters enforce hard constraints. The combination improves technical performance in terms of error reduction and policy compliance.

### 9. Exemplary Embodiments

In a first embodiment, the user uses a smartphone as the terminal and accesses a web application hosted by the server. The user selects a “historical scientist” persona and asks:
“Can you explain relativity in simple terms?” The server detects interest and mild confusion from the user's input, selects a scientist persona with a patient explanatory style, constructs a prompt sentence such as:
“You are a historical scientist. Answer the user's questions using that scientist's wording and thought patterns. The user asks: ‘Can you explain relativity in simple terms?’”
and sends it to the generative AI model. The server receives a detailed explanation, applies content filtering and tone adjustment, and returns the final response sentence to the smartphone, which displays it and optionally reads it aloud.

In a second embodiment, the user uses a head-mounted display as the terminal and initiates a conversation with a virtual fashion expert in a virtual store. The user says: “I am looking for a new suit and I feel a bit nervous about an upcoming interview.” The server converts speech to text, detects anxiety, selects a calming fashion advisor persona, retrieves suit information from a product database, and constructs a prompt sentence such as:
“You are a fashion expert helping a nervous user prepare for a job interview. The user said: ‘I am looking for a new suit and I feel a bit nervous about an upcoming interview.’ Suggest suit styles and colors using a calm and reassuring tone.”

The generative AI model returns tailored advice, which the server filters and sends back. The terminal then displays recommended suits and plays the advisor's voice.

In a third embodiment, the user uploads past messages of a deceased relative to the server through a personal computer. The server builds a person profile by extracting vocabulary patterns and topic tendencies from the uploaded texts. Later, when the user types: “I feel lonely today,” the server recognizes sadness, selects the deceased relative's persona, and constructs a prompt sentence such as:
“The user feels lonely and sad. Act as the user's deceased father, using gentle wording and everyday topics from the father's typical style. Provide warm, comforting words. User: ‘I feel lonely today.’”

The generative AI model produces a response in a manner consistent with the stored vocabulary and topics. The server post-processes and sends the final response sentence to the terminal for display.

### 10. Variations and Alternative Configurations

The server, in alternative embodiments, may use different neural architectures for emotion analysis, such as recurrent neural networks, convolutional neural networks, or transformer-based classifiers. The server may also use different distance metrics or similarity measures for mapping emotion vectors to persona attributes, such as cosine similarity, Euclidean distance, or learned metric functions.

The server, in some embodiments, may maintain multiple generative AI models specialized for different domains (for example, medicine, law, entertainment), and select one model based on person attributes and topics, thereby improving domain accuracy and reducing model size for each task.

The terminal, in other embodiments, may cache frequently used responses or partial prompts, and the server may send compact update messages to reduce communication load. For example, when a user repeatedly asks similar questions, the server can identify redundancy through hashing or vector similarity search and reuse previous generation results.

The described embodiments demonstrate how the server, the terminal, and the user cooperate to implement the claimed system. The described data structures, processing modules, and control flows enable a person skilled in the art to implement the invention without undue experimentation and show that the invention constitutes a concrete improvement in computer-implemented dialogue processing rather than an abstract mental process.

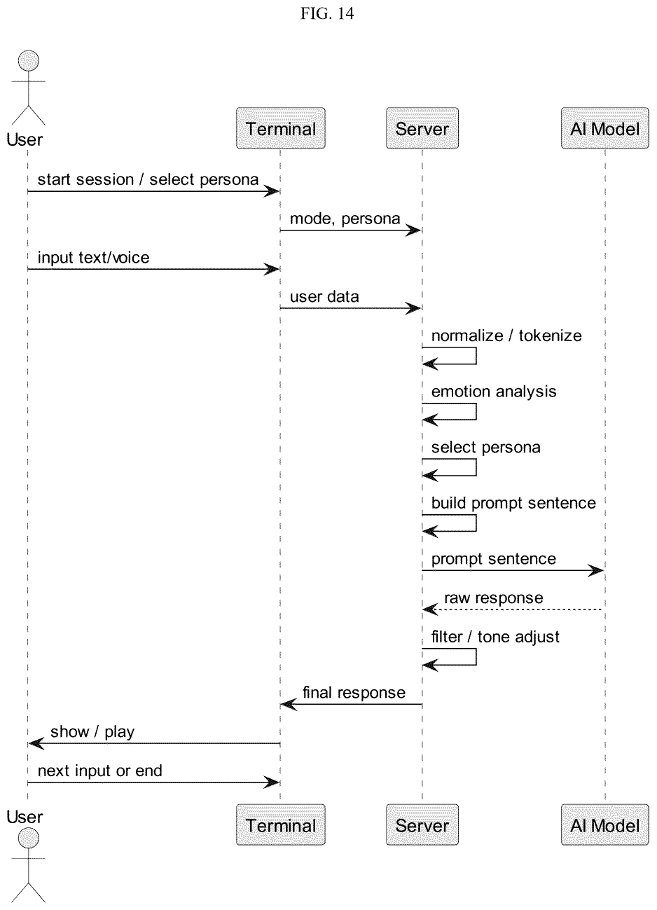

The following describes the processing flow using FIG. 14.

### Step 1

User operates the terminal and initiates a dialogue session.
User selects a mode (for example, expert consultation, historical persona, deceased relative) and optionally selects or specifies a target persona.
Input: User operation events (button presses, menu selections) and optional persona specification.
Output: Terminal state information including selected mode and persona identifier.
Terminal packages the mode and persona identifier into a structured message and sends it to the server via a communication interface.

### Step 2

User inputs an initial utterance via the terminal.
User enters text through a keyboard or touch interface, or speaks into a microphone.
Input: Text string or raw audio waveform.
Output: For text input, a text string; for voice input, an audio data buffer encoded in a predefined format.
Terminal attaches session identifiers and timestamps to the input and transmits the data to the server.

### Step 3

Server receives user input data from the terminal.
Server inspects the data type and determines whether the input is text or audio.
Input: Network packet containing user input data and associated metadata.
Output: Normalized input object containing the raw content and metadata fields (session ID, user ID, timestamp, persona ID).
Server stores the normalized input object in temporary memory for further processing.

### Step 4

Server converts audio input to text when necessary.
Server, when the input is audio, calls a speech recognition service and submits the audio buffer.
Input: Audio data buffer and recognition parameters (language, sampling rate).
Output: Transcribed text string and recognition confidence scores.
Server discards low-confidence segments or requests re-input if the confidence falls below a threshold, and adopts the resulting text as the user input text.

### Step 5

Server normalizes and tokenizes the user input text.
Server performs character normalization (encoding unification, case conversion, whitespace normalization) and executes tokenization using a natural language processing library.
Input: Raw user input text.
Output: Normalized text and a token sequence with token boundaries and part-of-speech tags.
Server stores the normalized text and tokens as part of the current turn data structure.

### Step 6

Server updates dialogue history with the new user turn.
Server allocates a new record in a dialogue history table and writes user ID, session ID, turn index, persona identifier, timestamp, and normalized text.
Input: Current turn data (IDs, normalized text) and existing dialogue history.
Output: Updated dialogue history including the new turn.
Server indexes the new record so that it can be retrieved efficiently for context construction.

### Step 7

Server generates dialogue context information.
Server retrieves a subset of recent turns for the same session, based on turn index and a maximum context length parameter.
Input: Dialogue history records for the session and a context length parameter.
Output: Dialogue context information including selected past turns, possibly summarized into shorter descriptions.
Server may summarize long histories by applying a lightweight summarization algorithm that compresses multiple turns into bullet points, and stores the context information in memory.

### Step 8

Server executes emotion analysis on the user input text.
Server converts tokens into feature vectors using a word embedding model or a contextual embedding model, and feeds the vectors into an emotion classifier network.
Input: Token sequence and associated embeddings.
Output: Emotion information consisting of a category label (for example, anxious, sad, joyful) and an emotion score vector.
Server stores the emotion information in an emotion history structure linked to the current turn.

### Step 9

Server smooths and updates the emotion history.
Server combines the current emotion vector with vectors from recent turns, for instance by computing a weighted average, to detect persistent tendencies.
Input: Current emotion vector and previous emotion vectors for the session.
Output: Smoothed emotion vector representing the current estimated emotional state.
Server records the smoothed emotion vector and updates the emotion history for future processing.

### Step 10

Server selects a persona attribute based on mode, user choice, and emotion.
Server accesses a persona registry containing candidate persona attributes and computes a score for each candidate using a function of the smoothed emotion vector, the selected mode, and any explicit user selection.
Input: Smoothed emotion vector, user-selected persona identifier, and persona registry data.
Output: Selected persona attribute that includes role category, style descriptors, and domain tags.
Server records the selected persona attribute in the conversation state information.

### Step 11

Server retrieves person profile information.
Server queries a storage device for person profile data associated with the selected persona attribute.
Input: Persona attribute identifier.
Output: Person profile information including compressed past utterance data, vocabulary pattern data, topic tendency data, and style descriptors.
Server loads the profile information into memory for use in prompt construction.

### Step 12

Server builds a persona style representation.
Server constructs a compact representation of the person's style by selecting high-frequency vocabulary items, characteristic n-grams, and dominant topics from the profile information.
Input: Person profile information (past utterances, vocabulary patterns, topic tendencies).
Output: Persona style representation summarizing wording tendencies, common phrases, and typical subject matter.
Server may create a short textual description and a list of exemplar phrases to embed into the prompt sentence.

### Step 13

Server composes a system instruction section for the prompt sentence.
Server generates a text segment that defines the generative AI model's role and global constraints.
Input: Selected persona attribute and system configuration rules.
Output: System instruction text such as a description of the role, safety constraints, and communication style.
Server ensures that the instruction text conforms to a maximum token budget for control sections.

### Step 14

Server composes a persona description section for the prompt sentence.
Server converts persona style representation into natural language, describing how the target person typically speaks and reasons.
Input: Persona style representation and person attributes.
Output: Persona description text specifying wording style, thought patterns, and typical topics.
Server includes exemplar phrases to anchor the generative AI model in the target style.

### Step 15

Server composes an emotion context section for the prompt sentence.
Server generates a short text section that explicitly describes the user's emotional state and desired response tone.
Input: Smoothed emotion vector and conversation tone mapping rules.
Output: Emotion context text indicating, for example, that the user is anxious and requires a calm response.
Server maps numeric emotion scores to descriptive phrases to guide the generative AI model.

### Step 16

Server composes a dialogue history summary section for the prompt sentence.
Server converts the dialogue context information into a concise textual summary that preserves essential facts and questions.
Input: Dialogue context information (selected past turns and summaries).
Output: History summary text capturing the main points of the ongoing conversation.
Server truncates or further compresses the summary when the token budget is tight.

### Step 17

Server appends the current user input section to the prompt sentence.
Server places the normalized current user input text at the end of the prompt, clearly labelled as the latest user message.
Input: Normalized current user input text.
Output: User input section text that will trigger a direct response from the generative AI model.
Server ensures that the user input is preserved verbatim to avoid altering meaning.

### Step 18

Server concatenates all prompt components into a final prompt sentence.
Server orders the system instruction, persona description, emotion context, history summary, and user input sections and concatenates them into a single text or a structured message sequence, depending on the generative AI model's interface.
Input: Individual text sections created in previous steps.
Output: Final prompt sentence ready for submission to the generative AI model.
Server checks total token count and, if necessary, reduces less critical sections while preserving key control information.

### Step 19

Server submits the prompt sentence to the generative AI model.
Server constructs an API request that includes the model identifier, the final prompt sentence, and generation parameters such as maximum output length and sampling temperature.
Input: Final prompt sentence and generation configuration parameters.
Output: Model request message sent over a network to the generative AI model endpoint.
Server invokes the model and awaits the response, handling timeouts or errors by retry or fallback strategies.

### Step 20

Generative AI model generates a response sentence.
Generative AI model receives the prompt sentence, converts tokens into internal embeddings, processes them through multiple attention and feedforward layers, and predicts an output token sequence.
Input: Prompt sentence tokens and model parameters.
Output: Generated response sentence as a sequence of tokens converted back to text.
Server receives the text as a provisional response for further processing.

### Step 21

Server performs content filtering on the response sentence.
Server applies rule-based checks and optional classifier models to identify prohibited content such as harmful advice, disallowed topics, or private information.
Input: Generated response sentence.
Output: Filtered response sentence with unsafe or inappropriate segments removed, masked, or replaced.
Server may instruct the model to regenerate a portion if the filtered result falls below a minimum completeness threshold.

### Step 22

Server performs tone adjustment processing on the response sentence.
Server analyzes the tone of the filtered response using a tone classifier that outputs scores for formality, positivity, calmness, and other attributes.
Input: Filtered response sentence and desired conversation tone attribute.
Output: Tone-adjusted response sentence in which specific expressions are softened, strengthened, or rephrased to match the target tone.
Server uses predefined substitution rules and, if necessary, a small generative model specialized for paraphrasing to correct tone deviations.

### Step 23

Server determines the final response sentence and updates conversation state.
Server selects the tone-adjusted response as the final response sentence and writes it into the dialogue history with associated emotion information, persona attribute, and timestamp.
Input: Tone-adjusted response sentence, current conversation state information, and emotion information.
Output: Updated conversation state information including last response text, last emotion, and last persona.
Server maintains a compact representation of the dialogue state to be reused in future turns.

### Step 24

Server transmits the final response sentence to the terminal.
Server encapsulates the final response sentence and metadata (persona name, emotion label, suggested next actions) in a structured message and sends it via the network interface.
Input: Final response sentence and metadata.
Output: Network packet delivered to the terminal.
Server logs transmission status for reliability monitoring.

### Step 25

Terminal renders the final response sentence to the user.
Terminal receives the message, extracts the response text and metadata, and displays the text in a dialogue interface together with a persona label or avatar.
Input: Network packet containing the final response sentence and metadata.
Output: Visual display on the screen and, if enabled, an audio playback.
Terminal, when audio mode is active, calls a text-to-speech engine to synthesize speech from the text and plays the resulting audio through a speaker or headphones.

### Step 26

User reviews the response and decides on a next action.
User reads the text or listens to the audio, evaluates whether the answer is sufficient or requires clarification, and either inputs a follow-up question, changes persona or topic, or ends the session.
Input: Displayed or spoken final response sentence.
Output: A new user action, such as a follow-up input or a session termination event.
User's next input, when provided, becomes the input for a new iteration starting from the earlier steps.

### Step 27

Server maintains and optimizes session-level behavior across multiple turns.
Server periodically analyzes aggregated dialogue history and emotion history to adjust internal parameters, such as maximum context size, persona selection weights, and prompt composition ratios.
Input: Accumulated dialogue and emotion data for the session or for multiple sessions.
Output: Updated configuration parameters and refined mapping rules that influence subsequent processing flows.
Server thereby improves response accuracy, reduces processing time by optimizing context truncation, and enhances stability of persona reproduction over continuing conversations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

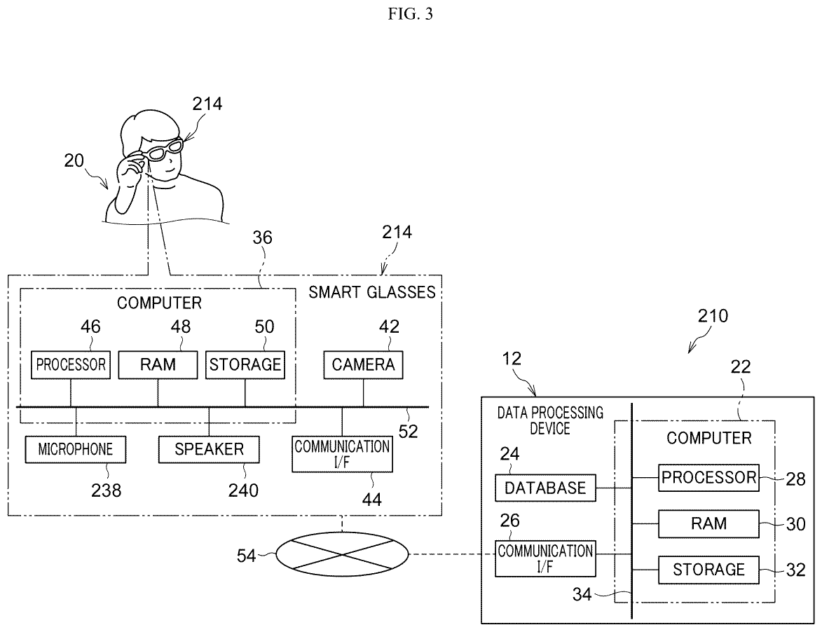

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

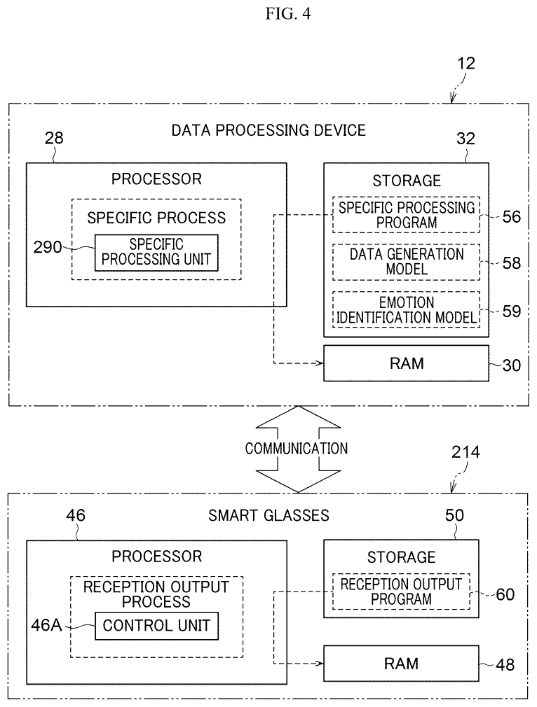

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

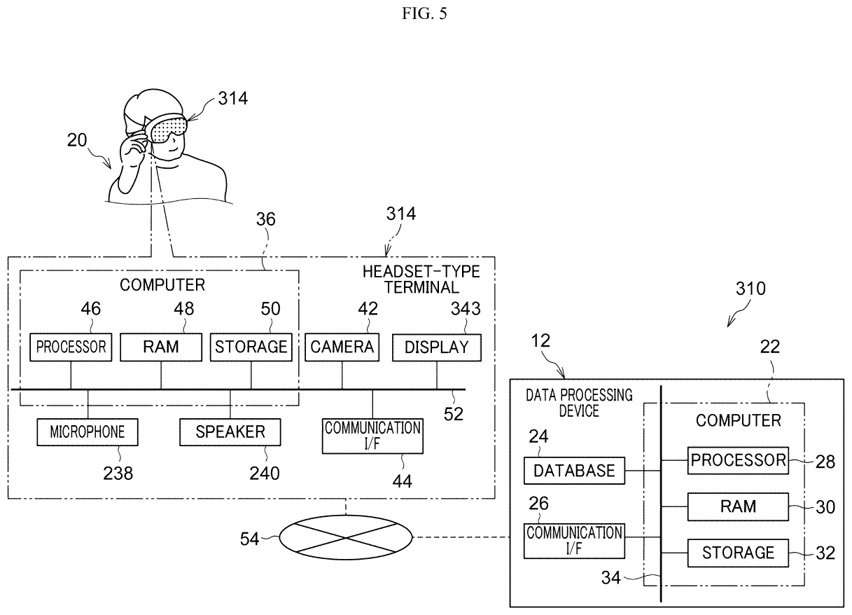

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

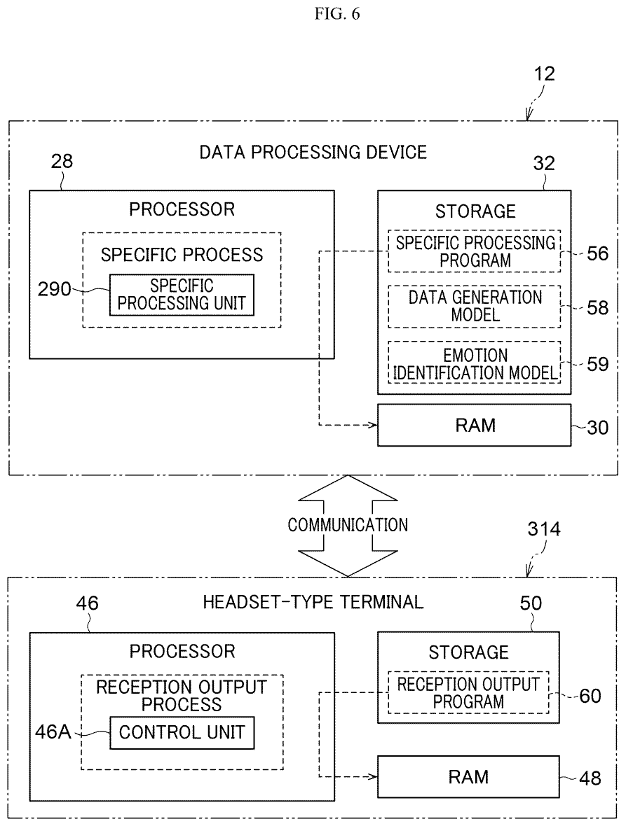

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

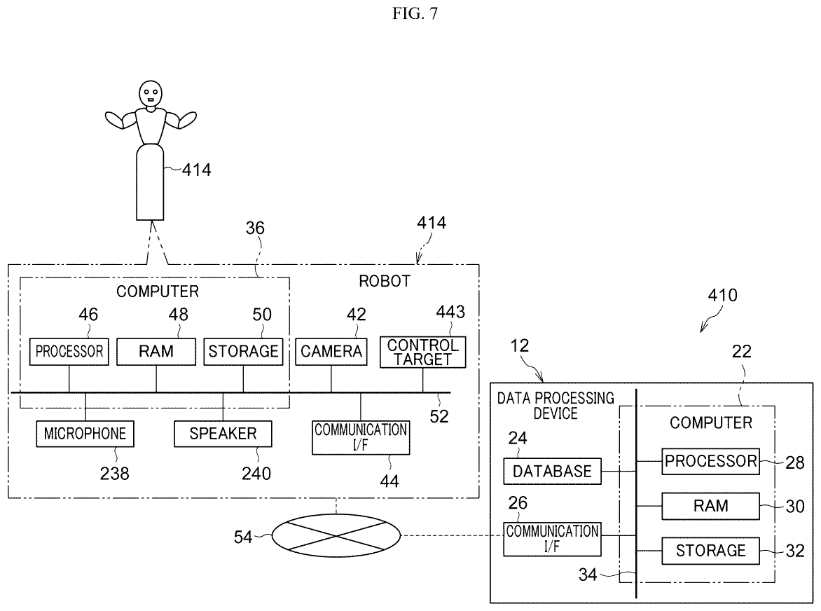

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

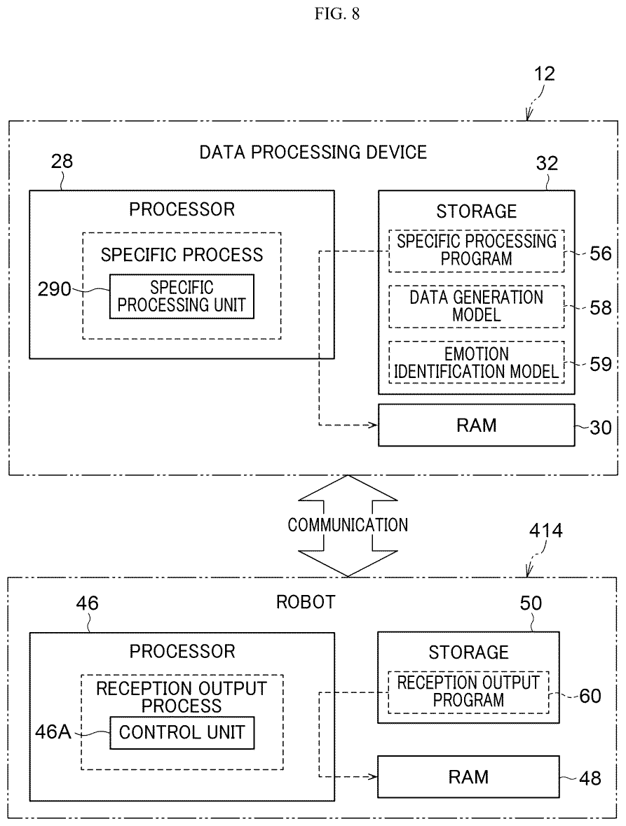

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

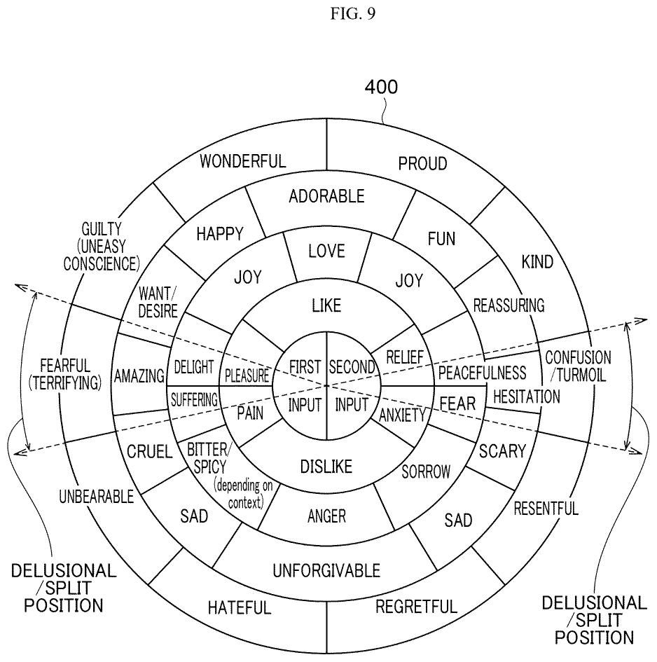

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

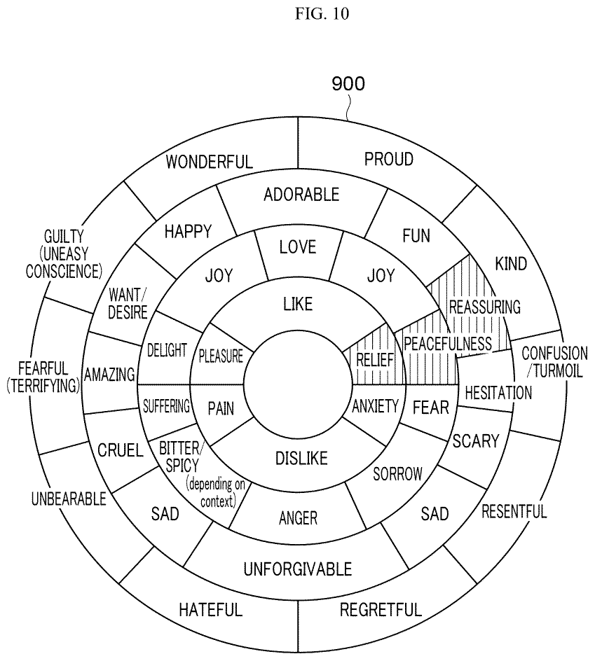

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, from an external storage unit, past conversation history data and behavior history data collected by a user, and read character information and audio information included in the past conversation history data and the behavior history data as analysis target data,
perform, on character information included in the analysis target data, segmentation processing, normalization processing, unnecessary information removal processing, and format conversion processing by using a natural language processing program, and integrate the processed character information as preprocessed character string data,
convert, by using a speech recognition program, audio information included in the analysis target data into character strings, perform the segmentation processing, normalization processing, unnecessary information removal processing, and format conversion processing on the converted character strings by using the natural language processing program, and add the resulting preprocessed character string data to the integrated preprocessed character string data,
generate utterance unit data from the integrated preprocessed character string data in accordance with speaker attributes, time attributes, and context attributes of a target individual, and construct a training data set for a generative AI model by using the utterance unit data,
adjust parameters or auxiliary parameters of the generative AI model by using the training data set, and generate a trained generative AI model that reflects a language expression style and topic preferences of the target individual,
receive an input character string from the user as a prompt sentence, designate the target individual for the trained generative AI model, and generate a model input prompt sentence including conversation conditions,
execute the trained generative AI model by using the model input prompt sentence and, as needed, past conversation history as input, and generate a response character string that mimics the language expression style and topic preferences of the target individual,
apply an emotion analysis algorithm to the input character string from the user and to a conversation situation, estimate an emotion state of the user, and control conversation content and a conversation tone by adjusting, according to the estimated emotion state, at least one of contents of the model input prompt sentence and generation conditions of the trained generative AI model, and
output the generated response character string to a user interface to present a conversation with the target individual to the user.

### Supplementary 2

The system according to supplementary 1,
wherein the processor is configured to
access, in addition to the past conversation history data and the behavior history data, a person information database stored in a storage unit, generate a target individual profile by using general person attribute information stored in the person information database, and incorporate the target individual profile into the model input prompt sentence to reproduce the target individual and generate the conversation.

### Supplementary 3

The system according to supplementary 1,
wherein the processor is configured to
execute the emotion analysis algorithm by using at least one of the input character string from the user, action history acquired from the user interface, and environment information, select an optimal target individual from among candidate target individuals based on an analysis result, and generate a prompt sentence for designating, to the trained generative AI model, model configuration information or a specific trained generative AI model corresponding to the selected target individual.

### Application Example 1

### Supplementary 1

A system comprising a processor and a storage device,
wherein the processor is configured to
receive audio information acquired from a user via a terminal, convert the audio information into character information, and generate a prompt sentence including the character information and target person identification information,
construct, based on the prompt sentence and attribute information and dialogue history information related to a target person and stored in the storage device, a prompt sentence that instructs a generative AI model to reproduce a speech style and a thought style of the target person, and obtain response character information that imitates a persona of the target person from the generative AI model,
execute a speech synthesis process based on the response character information and voice feature information associated with the target person, and generate audio data that imitates a voice of the target person,
transmit the audio data and the response character information to the terminal, and cause the terminal to present a virtual display object and to reproduce the audio data so as to provide the user with an interactive experience with the target person,
analyze an emotional state of the user based on input information from the user and the dialogue history information, and adjust instruction information regarding conversation content and conversation tone included in the prompt sentence according to an analysis result of the emotional state, and
control a continuous dialogue session by repeatedly executing user audio input processing, response generation by the generative AI model, the speech synthesis process, and transmission processing to the terminal.

### Supplementary 2

The system according to supplementary 1,
wherein the processor is configured to acquire, from a plurality of pieces of person information stored in the storage device, person information corresponding to the target person identification information, and to construct the prompt sentence for the generative AI model based on history information, document information, conversation record information, and feature expression information included in the person information, and to cause the generative AI model to generate the response character information according to attributes of the target person.

### Supplementary 3

The system according to supplementary 1,
wherein the processor is configured to apply an emotion analysis algorithm to input information acquired from the user to determine the emotional state of the user, to select, based on a relationship between the emotional state and a plurality of pieces of person information stored in the storage device, a target person suitable for dialogue, and to generate the prompt sentence that instructs reproduction of the selected target person.

### Example 2

### Supplementary 1

A system comprising a processor,
wherein the processor is configured to
receive, from a communication terminal, user input information and generate a prompt sentence including identification information indicating a person category to be a dialogue target, and input the prompt sentence to a generative AI model to instruct reproduction of a specific person category,
acquire, from an information set stored in a storage device, person-related information corresponding to the identification information, set, for the generative AI model, speaking-style information and thinking-pattern information for each person category as learning data on the basis of the person-related information, and generate model configuration information for dialogue generation in accordance with the person category,
generate an input sequence by combining the model configuration information and the prompt sentence, input the input sequence to the generative AI model to generate a response sentence, and transmit the response sentence to the communication terminal,
execute emotion analysis processing to estimate an emotional state of a user by using the user input information acquired from the communication terminal, generate adjustment information for changing content or an expression style of the response sentence in accordance with the emotional state, and correct the input sequence to the generative AI model or the response sentence on the basis of the adjustment information, and
select, on the basis of the emotional state and the person-related information, a person category suitable for dialogue with the user, and generate a new prompt sentence corresponding to the selected person category to switch input content to the generative AI model.

### Supplementary 2

The system according to supplementary 1,
wherein the processor is configured to
acquire, as the person-related information, structured information including document information, dialogue record information, explanatory information, and attribute information corresponding to a plurality of person categories from an information-set management apparatus, and convert the structured information into a learning-data format for the generative AI model by text normalization processing, segmentation processing, and encoding processing so as to enhance dialogue-generation performance for each person category.

### Supplementary 3

The system according to supplementary 1,
wherein the processor is configured to
hold, as history information, the user input information sequentially acquired from the communication terminal and the response sentence, input the history information added to the prompt sentence to the generative AI model so as to continuously generate the response sentence in accordance with the person category while maintaining a multi-turn dialogue context, and dynamically switch the person category by the selection of the person category in response to a change in the emotional state.

### Application Example 2

### Supplementary 1

A system comprising a processor,
wherein the processor is configured to
acquire user input data from a user terminal and generate dialogue context information based on the user input data and dialogue history, the dialogue context information being used for constructing a prompt sentence to be input to a generative AI model,
execute emotion analysis processing on the user input data to calculate emotion information indicating an emotional state of a user, and determine, based on the emotion information, a person attribute representing a target person to be reproduced and a conversation tone attribute,
acquire, from a storage device, person information and style information associated with the person attribute, and generate the prompt sentence by using the style information, the emotion information, and the dialogue context information so as to instruct the generative AI model to select and reproduce a specific person and to define wording, thought patterns, and conversation tone of the specific person,
input the prompt sentence to the generative AI model, cause the generative AI model to generate a response sentence reflecting the wording, thought patterns, and the conversation tone of the specific person, and perform content filtering processing and tone adjustment processing on a generation result to determine a final response sentence,
transmit the final response sentence to the user terminal and perform output control so that the final response sentence is presented by the user terminal as a text display or a speech synthesis output, and
store the user input data and the final response sentence as the dialogue history and update conversation state information so that the updated conversation state information is used for subsequent generation of the dialogue context information and the emotion information.

### Supplementary 2

The system according to supplementary 1,
wherein the processor is configured to
determine the person attribute based on person profile information generated using person-related data stored in the storage device and user-provided data, and embed at least a part of past utterance data, vocabulary pattern data, and topic tendency data included in the person profile information into the prompt sentence so that a conversation style of a specific person is reflected in generation of the response sentence by the generative AI model.

### Supplementary 3

The system according to supplementary 1,
wherein the processor is configured to
select, based on the emotion information, the person attribute from among a plurality of types of person attributes associated with the emotion information, the selected person attribute being designed to mitigate or amplify the emotional state of the user, and reflect the selected person attribute in the prompt sentence so that conversation content and the conversation tone are dynamically changed in accordance with the emotional state of the user.

What is claimed is:

1. A system comprising:
circuitry configured to:
acquire, from a storage device, conversation history data and behavior history data comprising character information and audio information, and apply natural language processing comprising segmentation processing, normalization processing, and format conversion processing to the character information to produce preprocessed character string data;
convert the audio information into character strings using a speech recognition program and apply the natural language processing to the converted character strings to append resulting preprocessed character string data to the preprocessed character string data;
generate utterance unit data from the integrated preprocessed character string data in accordance with speaker attributes, time attributes, and context attributes of a target individual and construct a training data set using the utterance unit data;
adjust parameters of a generative neural network model using the training data set to produce a trained generative neural network model that reflects a language expression style and topic preferences of the target individual;
receive an input character string via a communication interface coupled to a packet-switched network from a terminal device, construct a model input prompt sentence including conversation conditions and past conversation history, and execute the trained generative neural network model using the model input prompt sentence to generate a response character string; and
apply an emotion analysis algorithm to at least the input character string and a conversation situation to estimate an emotion state, and adjust at least one of contents of the model input prompt sentence and generation conditions of the trained generative neural network model based on the estimated emotion state before generating the response character string.

2. The system of claim 1, wherein the circuitry is configured to apply the segmentation processing by tokenizing character information into sentence units using a sentence boundary detection algorithm, and apply the normalization processing by converting character encodings, removing markup elements, and standardizing whitespace patterns.

3. The system of claim 2, wherein the circuitry is configured to apply the format conversion processing by mapping tokenized sentence units to a unified schema comprising a speaker identifier field, a timestamp field, and a content field, producing format-normalized records stored in the storage device.

4. The system of claim 3, wherein the circuitry is configured to construct the training data set by grouping utterance unit data records by the context attributes of the target individual and partitioning the grouped records into training and validation subsets for parameter adjustment.

5. The system of claim 4, wherein the circuitry is configured to adjust parameters of the generative neural network model by computing a cross-entropy loss between model-generated token sequences and reference utterance sequences from the training data set and updating model weights using backpropagation with a gradient-based optimization algorithm.

6. The system of claim 1, wherein the circuitry is configured to construct the model input prompt sentence by concatenating a persona description section specifying the speaker attributes of the target individual, a conversation conditions section, and a recent conversation history section extracted from the storage device.

7. The system of claim 6, wherein the circuitry is configured to limit the recent conversation history section to a sliding window of the most recent interaction records based on a token budget constraint, and to update the sliding window with each new response character string added to the storage device.

8. The system of claim 7, wherein the circuitry is configured to append a conversation instruction section to the model input prompt sentence that specifies generation conditions including output length, formality level, and topic focus derived from the speaker attributes of the target individual.

9. The system of claim 1, wherein the emotion analysis algorithm applies a multi-class emotion classification model to input token embeddings extracted from the input character string and applies a conversation-situation feature vector derived from recent interaction metadata, producing an emotion state label and an emotion intensity score.

10. The system of claim 9, wherein the circuitry is configured to adjust the contents of the model input prompt sentence based on the emotion state label by inserting or replacing a tone instruction section specifying a conversational adjustment corresponding to the detected emotion state.

11. The system of claim 10, wherein the circuitry is configured to adjust the generation conditions by modifying a sampling temperature parameter of the trained generative neural network model based on the emotion intensity score, lowering temperature when high confidence emotion is detected and raising temperature when ambiguous emotion is detected.

12. The system of claim 1, wherein the circuitry is configured to store the generated response character string together with the input character string, the estimated emotion state label, and the emotion intensity score as a new conversation history record in the storage device for use in subsequent training data set construction.

13. The system of claim 12, wherein the circuitry is configured to trigger incremental parameter adjustment of the trained generative neural network model using newly accumulated conversation history records when a threshold number of new records is reached.

14. The system of claim 13, wherein the incremental parameter adjustment applies low-rank matrix decomposition to limit updates to auxiliary parameters while preserving base model weights, and stores updated auxiliary parameters in the storage device.

15. The system of claim 1, wherein the circuitry is configured to convert the audio information using the speech recognition program by extracting acoustic feature vectors and applying a neural network-based sequence-to-sequence model to produce transcribed character strings.

16. The system of claim 15, wherein the acoustic feature vectors comprise Mel-frequency cepstral coefficients computed per audio frame, and the circuitry is configured to apply speaker diarization to assign speaker identifier labels to each transcribed segment.

17. The system of claim 1, wherein the circuitry is configured to transmit the response character string to the terminal device via the communication interface and update the conversation history data in the storage device with the transmitted response character string and associated metadata.

18. A system comprising:
circuitry configured to:
acquire conversation history data and behavior history data from a storage device, apply natural language processing comprising segmentation, normalization, and format conversion to character information to produce preprocessed character string data, convert audio information using a speech recognition program and append resulting character string data to the preprocessed character string data;
generate utterance unit data organized by speaker attributes, time attributes, and context attributes of a target individual and adjust parameters of a generative neural network model using a training data set constructed from the utterance unit data to produce a trained generative neural network model reflecting a language expression style of the target individual;
receive an input character string via a communication interface coupled to a packet-switched network from a terminal device and construct a model input prompt sentence concatenating a persona description section, a conversation conditions section, and a sliding-window conversation history section subject to a token budget constraint;
apply a multi-class emotion classification model to input token embeddings and a conversation-situation feature vector to estimate an emotion state label and an emotion intensity score, and adjust the model input prompt sentence and a sampling temperature parameter of the trained generative neural network model based on the emotion state label and the emotion intensity score;
execute the trained generative neural network model using the adjusted model input prompt sentence to generate a response character string and transmit the response character string to the terminal device via the communication interface; and
store the response character string together with the emotion state label and the emotion intensity score as a new conversation history record and trigger incremental parameter adjustment when accumulated new records exceed a threshold count.

19. The system of claim 18, wherein the incremental parameter adjustment applies low-rank matrix decomposition to limit updates to auxiliary parameters of the trained generative neural network model, and the circuitry is configured to validate updated auxiliary parameters using a held-out validation subset before committing the parameters to the storage device.

20. A method comprising:
acquiring, from a storage device, conversation history data and behavior history data comprising character information and audio information, and applying natural language processing comprising segmentation processing, normalization processing, and format conversion processing to produce preprocessed character string data;
generating utterance unit data from the preprocessed character string data in accordance with speaker attributes, time attributes, and context attributes of a target individual and constructing a training data set from the utterance unit data;
adjusting parameters of a generative neural network model using the training data set to produce a trained generative neural network model reflecting a language expression style and topic preferences of the target individual;
receiving an input character string via a communication interface coupled to a packet-switched network from a terminal device, constructing a model input prompt sentence including conversation conditions and conversation history, and executing the trained generative neural network model to generate a response character string; and
applying an emotion analysis algorithm to the input character string to estimate an emotion state and adjusting at least one of the model input prompt sentence and generation conditions of the trained generative neural network model based on the estimated emotion state.
